(19) United States
(12) Patent Application Publication
(10) Pub. No.: US 2020/0305191 A1
(43) Pub. Date: Sep. 24, 2020

(54) METHOD AND APPARATUS FOR TRANSMITTING AND RECEIVING SIGNAL IN COMMUNICATION SYSTEM SUPPORTING UNLICENSED BAND

(71) Applicant: ELECTRONICS AND TELECOMMUNICATIONS RESEARCH INSTITUTE, Daejeon (KR)

(72) Inventors: Sung Hyun MOON, Daejeon (KR); Cheul Soon KIM, Daejeon (KR); Jung Hoon LEE, Daejeon (KR)

(73) Assignee: ELECTRONICS AND TELECOMMUNICATIONS RESEARCH INSTITUTE, Daejeon (KR)

(21) Appl. No.: 16/826,162

(22) Filed: Mar. 20, 2020

(30) Foreign Application Priority Data
Mar. 22, 2019 (KR) 10-2019-0032829
Mar. 10, 2020 (KR) 10-2020-0029391

(51) Int. Cl. H04W 74/08; H04W 16/14; H04W 72/12

(52) U.S. Cl. CPC H04W 74/0808; H04W 72/1268; H04W 72/1289; H04W 16/14

(57) ABSTRACT

Disclosed are methods and apparatuses for transmitting and receiving signals in a communication system supporting unlicensed bands. An operation method of a terminal may comprise acquiring a time period for occupying a channel by performing a sensing operation on the channel; transmitting a first uplink signal to a base station in a first uplink period within the time period; receiving DCI from the base station in a downlink period within the time period, the DCI including an uplink grant; and transmitting a second uplink signal to the base station in a second uplink period indicated by the uplink grant within the time period. Thus, performance of the communication system can be improved.

### CROSS-REFERENCE TO RELATED APPLICATIONS

This application claims priority to Korean Patent Applications No. 10-2019-0032829 filed on Mar. 22, 2019 and No. 10-2020-0029391 filed on Mar. 10, 2020 with the Korean Intellectual Property Office (KIPO), the entire contents of which are hereby incorporated by reference.

### BACKGROUND

### 1. Technical Field

The present disclosure relates generally to techniques for transmitting and receiving signals in a communication system, and more specifically, to techniques for accessing a channel and transmitting/receiving signals in a communication system supporting unlicensed bands.

### 2. Related Art

The communication system (hereinafter, a new radio (NR) communication system) using a higher frequency band (e.g., a frequency band of 6 GHz or higher) than a frequency band (e.g., a frequency band lower below 6 GHz) of the long term evolution (LTE) (or, LTE-A) is being considered for processing of soaring wireless data. The NR communication system may support not only a frequency band below 6 GHz but also 6 GHz or higher frequency band, and may support various communication services and scenarios as compared to the LTE communication system. For example, usage scenarios of the NR communication system may include enhanced mobile broadband (eMBB), ultra-reliable low-latency communication (URLLC), massive machine type communication (mMTC), and the like.

Meanwhile, communications through unlicensed bands may be used to process rapidly increasing wireless data. Currently, communication technologies that use unlicensed bands include LTE-Unlicensed (LTE-U), Licensed-Assisted-Access (LAA), MultiFire, and the like. In addition to the existing functions, the NR communication system can support a standalone mode that independently operates only in unlicensed bands. However, an initial access procedure, a signal transmission procedure, a channel access scheme suitable for a flexible frame structure, a wideband carrier operation, and the like in unlicensed bands are not yet clearly defined. In this reason, operations of a base station and terminals for the above-described technical elements need to be clearly defined.

### SUMMARY

Accordingly, exemplary embodiments of the present disclosure provide methods and apparatuses for transmitting and receiving signals in a communication system supporting unlicensed bands.

According to an exemplary embodiment of the present disclosure, an operation method of a terminal in a communication system may comprise acquiring a time period for occupying a channel by performing a sensing operation on the channel; transmitting a first uplink signal to a base station in a first uplink period within the time period; receiving downlink control information (DCI) from the base station in a downlink period within the time period, the DCI including an uplink grant; and transmitting a second uplink signal to the base station in a second uplink period indicated by the uplink grant within the time period.

The second uplink period may be located after the downlink period and may belong to the time period.

Information indicating an end time of the time period or information indicating whether the second uplink period belongs to the time period may be transmitted from the terminal to the base station.

The time period initiated by the terminal may be shared with the base station, and configuration information of the downlink period may be transmitted from the terminal to the base station.

A transmission resource of the second uplink signal may be overlapped with a transmission resource of a physical uplink shared channel (PUSCH) indicated by a configured grant (CG), and the PUSCH indicated by the CG may be not transmitted

A sensing operation on the channel for transmitting the second uplink signal may be performed, and information indicating the sensing operation on the channel for transmitting the second uplink signal may be transmitted from the base station to the terminal.

The second uplink signal may include one or more among a PUSCH, a physical uplink control channel (PUCCH), and a sounding reference signal (SRS), and the PUCCH includes one or more among a hybrid automatic repeat request acknowledgement (HARQ-ACK) for a physical downlink shared channel (PDSCH) received from the base station, channel state information (CSI), measurement information of downlink received signal strength, and a scheduling request.

According to another exemplary embodiment of the present disclosure, an operation method of a base station in a communication system may comprise receiving a first uplink signal from a terminal in a first uplink period within a time period initiated by the terminal; transmitting downlink control information (DCI) to the terminal in a downlink period within the time period, the DCI including an uplink grant; and receiving a second uplink signal from the terminal in a second uplink period indicated by the uplink grant within the time period.

The second uplink period may be located after the downlink period and may belong to the time period.

Information indicating an end time of the time period or information indicating whether the second uplink period belongs to the time period may be received from the terminal.

The time period initiated by the terminal may be shared with the base station, and configuration information of the downlink period may be received from the terminal.

A transmission resource of the second uplink signal may be overlapped with a transmission resource of a physical uplink shared channel (PUSCH) indicated by a configured grant (CG), and the PUSCH indicated by the CG may be not received.

Information indicating whether a third uplink signal according to a CG is transmittable in CG resources indicated by the CG after the downlink period within the time period may be transmitted to the terminal in the downlink period.

The second uplink signal may include one or more among a PUSCH, a physical uplink control channel (PUCCH), and a sounding reference signal (SRS), and the PUCCH includes one or more among a hybrid automatic repeat request acknowledgement (HARQ-ACK) for a physical downlink shared channel (PDSCH) transmitted from the base station, channel state information (CSI), measurement information of downlink received signal strength, and a scheduling request.

According to yet another exemplary embodiment of the present disclosure, a terminal in a communication system may comprise a processor; and a memory storing at least one instruction and electronically communicating with the processor. Also, when the at least one instruction is executed by the processor, the at least one instruction may cause the processor to acquire a time period for occupying a channel by performing a sensing operation on the channel; transmit a first uplink signal to a base station in a first uplink period within the time period; receive downlink control information (DCI) from the base station in a downlink period within the time period, the DCI including an uplink grant; and transmit a second uplink signal to the base station in a second uplink period indicated by the uplink grant within the time period.

The second uplink period may be located after the downlink period and may belong to the time period.

The time period initiated by the terminal may be shared with the base station, and configuration information of the downlink period may be transmitted from the terminal to the base station.

The transmission resource of the second uplink signal may be overlapped with a transmission resource of a physical uplink shared channel (PUSCH) indicated by a configured grant (CG), and the PUSCH indicated by the CG may be not transmitted.

Information indicating that the time period initiated by the terminal is intercepted by the base station may be received from the terminal in the downlink period.

The second uplink signal may include one or more among a PUSCH, a physical uplink control channel (PUCCH), and a sounding reference signal (SRS), and the PUCCH includes one or more among a hybrid automatic repeat request acknowledgement (HARQ-ACK) for a physical downlink shared channel (PDSCH) received from the base station, channel state information (CSI), measurement information of downlink received signal strength, and a scheduling request.

According to the exemplary embodiments of the present disclosure, a channel occupancy time (COT) initiated by a terminal may be shared with a base station. The base station may transmit an uplink grant to the terminal in a downlink period within the COT, and may receive an uplink signal from the terminal in an uplink period within the COT, which is indicated by the uplink grant. That is, when the COT initiated by the terminal is shared with the base station and the communication controlled by the terminal within the corresponding COT is terminated, the communication within the corresponding COT may be performed under control of the base station instead of the terminal. Thus, radio resources can be used efficiently, and the performance of the communication system can be improved.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating a first exemplary embodiment of a communication system;

FIG. 2 is a block diagram illustrating a first exemplary embodiment of a communication node constituting a communication system;

FIG. 3A is a conceptual diagram illustrating a first exemplary embodiment of a method for communications within a COT;

FIG. 3B is a conceptual diagram illustrating a second exemplary embodiment of a method for communications within a COT;

FIG. 4A is a conceptual diagram illustrating a first exemplary embodiment of a method of configuring CG resources;

FIG. 4B is a conceptual diagram illustrating a second exemplary embodiment of a method of configuring CG resources;

FIG. 5A is a conceptual diagram illustrating a first exemplary embodiment of a discontinuous PUSCH transmission method within one COT;

FIG. 5B is a conceptual diagram illustrating a second exemplary embodiment of a discontinuous PUSCH transmission method within one COT;

FIG. 6 is a conceptual diagram illustrating a first exemplary embodiment of a method for configuring a downlink period within a COT initiated by a terminal;

FIG. 7A is a conceptual diagram illustrating a first exemplary embodiment of a method of transmitting a downlink signal within a COT initiated by a terminal;

FIG. 7B is a conceptual diagram illustrating a second exemplary embodiment of a method of transmitting a downlink signal within a COT initiated by a terminal;

FIG. 7C is a conceptual diagram illustrating a third exemplary embodiment of a method of transmitting a downlink signal within a COT initiated by a terminal;

FIG. 8 is a conceptual diagram illustrating a fourth exemplary embodiment of a method for transmitting a downlink signal within a COT initiated by a terminal;

FIG. 9 is a conceptual diagram illustrating a first exemplary embodiment of a method for early terminating a COT initiated by a terminal;

FIG. 10A is a conceptual diagram illustrating a first exemplary embodiment of a channel occupancy method of a terminal considering a DRS related window;

FIG. 10B is a conceptual diagram illustrating a second exemplary embodiment of a channel occupancy method of a terminal considering a DRS related window;

FIG. 11A is a conceptual diagram illustrating a first exemplary embodiment in which a plurality of terminals simultaneously access the same channel; and

FIG. 11B is a conceptual diagram illustrating a second exemplary embodiment in which a plurality of terminals simultaneously access the same channel.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

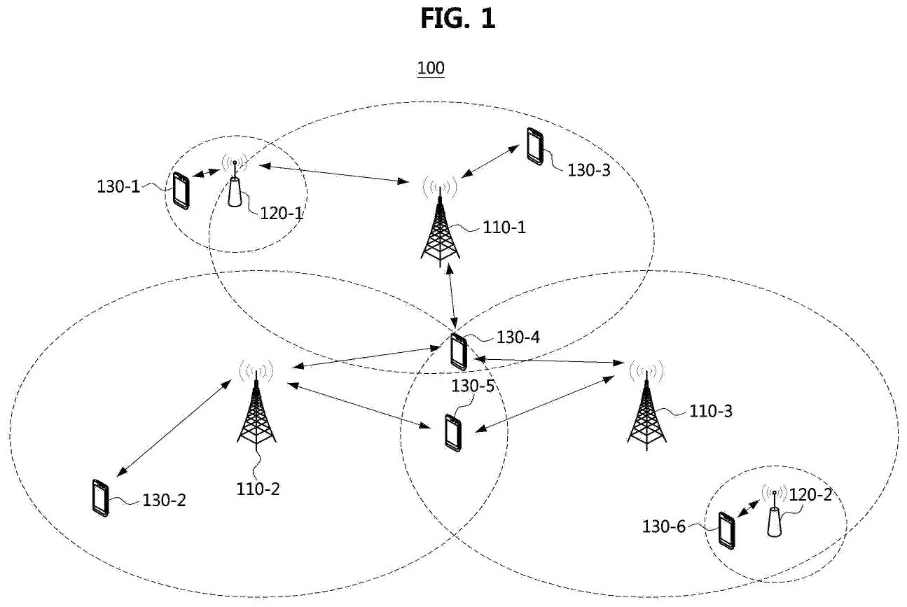

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3^{rd} generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

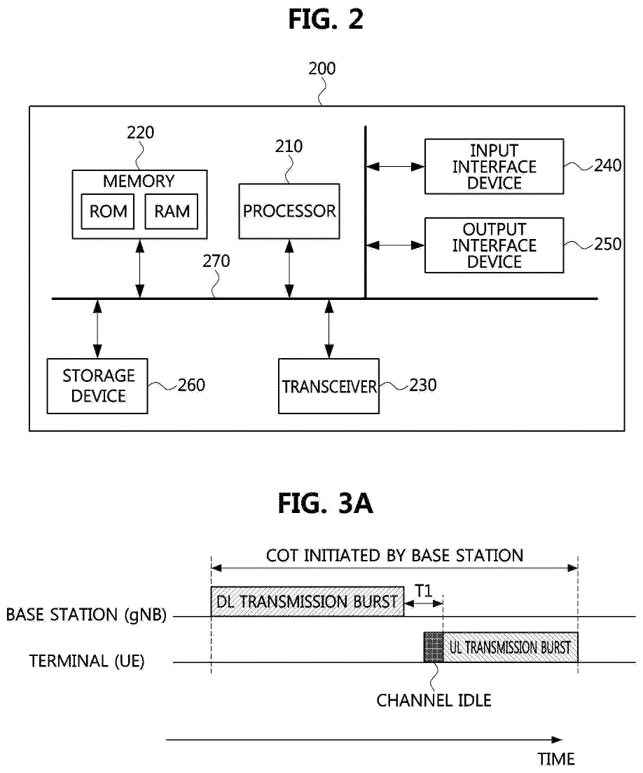

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed bands, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system (e.g., NR communication system) may support one or more services among an enhanced mobile broadband (eMBB) service, an ultra-reliable and low-latency communication (URLLC) service, and a massive machine type communication (mMTC) service. The communications may be performed to satisfy technical requirements of the services in the communication system. In the URLLC service, the requirement of the transmission reliability may be 1-10⁵, and the requirement of the uplink and downlink user plane latency may be 0.5 ms.

In the following exemplary embodiments, a channel occupancy method, a method of transmitting and receiving control information related to a channel occupancy time (i.e., COT to be described later), etc. in a communication system supporting unlicensed bands will be described. The exemplary embodiments below may also be applied to other communication systems (e.g., LTE communication system) as well as the NR communication system.

The NR communication system may support a wider system bandwidth (e.g., carrier bandwidth) than a system bandwidth provided by the LTE communication system in order to efficiently use a wide frequency band. For example, the maximum system bandwidth supported by the LTE communication system may be 20 MHz. On the other hand, the NR communication system may support a carrier bandwidth of up to 100 MHz in the frequency band of 6 GHz or below, and support a carrier bandwidth of up to 400 MHz in the frequency band of 6 GHz or above.

A numerology applied to physical signals and channels in the communication system may vary. The numerology may vary to satisfy various technical requirements of the communication system. In the communication system to which a cyclic prefix (CP) based OFDM waveform technology is applied, the numerology may include a subcarrier spacing and a CP length (or CP type). Table 1 below may be a first exemplary embodiment of configuration of numerologies for the CP-based OFDM. The subcarrier spacings may have a power of two multiplication relationship, and the CP length may be scaled at the same ratio as the OFDM symbol length. Depending on a frequency band in which the communication system operates, some of the numerologies of Table 1 may be supported. When the subcarrier spacing is 60 kHz, an extended CP may be additionally supported.

TABLE 1

| Subcarrier spacing | 15 kHz | 30 kHz | 60 kHz | 120 kHz | 240 kHz |
|---|---|---|---|---|---|
| OFDM symbol | 66.7 | 33.3 | 16.7 | 8.3 | 4.2 |
| length [μs] | | | | | |
| CP length [μs] | 4.76 | 2.38 | 1.19 | 0.60 | 0.30 |
| Number of OFDM | 14 | 28 | 56 | 112 | 224 |
| symbols within 1 ms | | | | | |

In the following description, a frame structure in the communication system will be described. In the time domain, a building block may be a subframe, a slot, and/or a minislot. The subframe may be used as a transmission unit, and the length of the subframe may have a fixed value (e.g., 1 ms) regardless of the subcarrier spacing. When a normal CP is used, the slot may comprise consecutive symbols (e.g., 14 OFDM symbols). The length of the slot may be variable differently from the length of the subframe, and may be inversely proportional to the subcarrier spacing. The slot may be used as a scheduling unit and may be used as a configuration unit of scheduling and hybrid automatic repeat request (HARQ) timing. The length of the actual time resource used for each scheduling may not match the length of the slot.

The base station may schedule a data channel (e.g., physical downlink shared channel (PDSCH), physical uplink shared channel (PUSCH), or physical sidelink shared channel (PSSCH)) using a part of the slot or an entire slot. Alternatively, the base station may schedule a data channel using a plurality of slots. A minislot may be used as a transmission unit, and the length of the minislot may be set shorter than the length of a slot. For example, the minislot may be a scheduling or transmission unit having a length shorter than that of a slot. A slot having a length shorter than the length of the conventional slot may be referred to as a ‘minislot’ in the communication system. The minislot-based scheduling operation may be used for partial slot transmission, URLLC data transmission, analog beamforming-based multi-user scheduling, etc. in unlicensed bands or a band where the NR communication system and the LTE communication system coexist. In the NR communication system, by configuring a physical downlink control channel (PDCCH) monitoring periodicity and/or a duration of a data channel to be shorter than the existing slot, minislot-based transmission can be supported.

In the frequency domain of the NR communication system, a building block may be a physical resource block (PRB). One PRB may comprise consecutive subcarriers (e.g., 12 subcarriers) regardless of the subcarrier spacing. Thus, a bandwidth occupied by one PRB may be proportional to the subcarrier spacing of the numerology. The PRB may be used as a resource allocation unit of a control channel and/or a data channel in a frequency domain. The minimum resource allocation unit of the downlink control channel may be a control channel element (CCE). One CCE may include one or more PRBs. Resource allocation for a data channel may be performed in unit of a PRB or a resource block group (RBG). One RBG may include one or more consecutive PRBs.

A slot (e.g., slot format) may be composed of a combination of one or more of downlink period, flexible period (or unknown period), and an uplink period. Each of the downlink period, the flexible period, and the uplink period may be comprised of one or more consecutive symbols. The flexible period may be located between a downlink period and an uplink period, between a first downlink period and a second downlink period, or between a first uplink period and a second uplink period. When the flexible period is inserted between the downlink period and the uplink period, the flexible period may be used as a guard period.

One slot may include a plurality of flexible periods. Alternatively, one slot may not include one flexible period. The terminal may perform a predefined operation or an operation configured by the base station semi-statically or periodically (e.g., PDCCH monitoring operation, synchronization signal/physical broadcast channel (SS/PBCH) block reception and measurement operation, channel state information-reference signal (CSI-RS) reception and measurement operation, downlink semi-persistent scheduling (SPS) PDSCH reception operation, sounding reference signal (SRS) transmission operation, physical random access channel (PRACH) transmission operation, periodically-configured PUCCH transmission operation, PUSCH transmission operation according to a configured grant, or the like) in a flexible symbol until the corresponding flexible period is overridden to be a downlink symbol or an uplink symbol. Alternatively, the terminal may not perform any operation in the corresponding flexible symbol until the corresponding flexible period is overridden to be a downlink symbol or an uplink symbol.

The slot format may be configured semi-statically by higher layer signaling (e.g. radio resource control (RRC) signaling). Information indicating a semi-static slot format may be included in system information, and the semi-static slot format may be configured in a cell-specific manner. For example, a cell-specific slot format may be configured through an RRC parameter ‘TDD-UL-DL-ConfigCommon’. In addition, the slot format may be additionally configured for each terminal through terminal-specific (i.e., UE-specific) higher layer signaling (e.g., RRC signaling). For example, a UE-specific slot format may be configured through an RRC parameter ‘TDD-UL-DL-ConfigDedicated’. A flexible symbol of the slot format configured in the cell-specific manner may be overridden by the terminal-specific higher layer signaling to a downlink symbol or an uplink symbol. Also, the slot format may be dynamically indicated by a slot format indicator (SFI) included in downlink control information (DCI).

The terminal may perform downlink operations, uplink operations, and sidelink operations in a bandwidth part. The bandwidth part may be defined as a set of consecutive PRBs having a specific numerology in the frequency domain. Only one numerology may be used for transmission of a control channel or a data channel in one bandwidth part. The terminal performing an initial access procedure may obtain configuration information of an initial bandwidth part from the base station through system information. A terminal operating in an RRC connected state may obtain the configuration information of the bandwidth part from the base station through terminal-specific higher layer signaling.

The configuration information of the bandwidth part may include a numerology (e.g., a subcarrier spacing and a CP length) applied to the bandwidth part. Also, the configuration information of the bandwidth part may further include information indicating a position of a starting PRB of the bandwidth part and information indicating the number of PRBs constituting the bandwidth part. At least one bandwidth part among the bandwidth part(s) configured in the terminal may be activated. For example, within one carrier, one uplink bandwidth part and one downlink bandwidth part may be activated respectively. In a time division duplex (TDD) based communication system, a pair of one uplink bandwidth part and one downlink bandwidth part may be activated. The base station may configure a plurality of bandwidth parts to the terminal within one carrier, and may switch the active bandwidth part of the terminal.

In the exemplary embodiments, the expression that a certain frequency band (e.g., carrier, bandwidth part, listen before talk (LBT) subband, guard band, etc.) is activated may mean that the certain frequency band is in a state in which a base station or a terminal can transmit or receive a signal by using the corresponding frequency band. In addition, an expression that a certain frequency band is activated may mean that the certain frequency band is in a state in which a radio frequency (RF) filter (e.g., band pass filter) of a transceiver is operating including the frequency band.

The minimum resource unit constituting a PDCCH may be a resource element group (REG). The REG may be composed of one PRB (e.g., 12 subcarriers) in the frequency domain and one OFDM symbol in the time domain. Thus, one REG may include 12 resource elements (REs). A demodulation reference signal (DMRS) for demodulating the PDCCH may be mapped to 3 REs among 12 REs constituting the REG, and control information (e.g., modulated DCI) may be mapped to the remaining 9 REs.

One PDCCH candidate may be composed of one CCE or aggregated CCEs. One CCE may be composed of a plurality of REGs. The NR communication system may support CCE aggregation levels 1, 2, 4, 8, 16, and the like, and one CCE may consist of six REGs.

A control resource set (CORESET) may be a resource region in which the terminal performs a blind decoding on PDCCHs. The CORESET may be composed of a plurality of REGs. The CORESET may consist of one or more PRBs in the frequency domain and one or more symbols (e.g., OFDM symbols) in the time domain. The symbols constituting one CORESET may be consecutive in the time domain. The PRBs constituting one CORESET may be continuous or discontinuous in the frequency domain. One DCI (e.g., one PDCCH) may be transmitted within one CORESET. A plurality of CORESETs may be configured with respect to a cell and a terminal, and the plurality of CORESETs may overlap in time-frequency resources.

The CORESET may be configured in the terminal by a PBCH (e.g., system information transmitted through the PBCH). The identifier (ID) of the CORESET configured by the PBCH may be 0. That is, the CORESET configured by the PBCH may be referred to as a CORESET #0. The terminal operating in an RRC idle state may perform a monitoring operation in the CORESET #0 in order to receive a first PDCCH in the initial access procedure. Not only terminals operating in the RRC idle state but also terminals operating in the RRC connected state may perform monitoring operations in the CORESET #0. The CORESET may be configured in the terminal by other system information (e.g., system information block type 1 (SIB1)) other than the system information transmitted through the PBCH. For example, for reception of a random access response (or Msg2) in a random access procedure, the terminal may receive the SIB1 including the configuration information of the CORESET. Also, the CORESET may be configured in the terminal by terminal-specific higher layer signaling (e.g., RRC signaling).

In each downlink bandwidth part, one or more CORESETs may be configured for the terminal. Here, the expression that the CORESET is configured in the bandwidth part may mean that the CORESET is logically associated with the bandwidth part and the terminal monitors the corresponding CORESET in the bandwidth part. The initial downlink active bandwidth part may include the CORESET #0 and may be associated with the CORESET #0. The CORESET #0 having a quasi-co-location (QCL) relation with an SS/PBCH block may be configured for the terminal in a primary cell (PCell), a secondary cell (SCell), and a primary secondary cell (PSCell). In the secondary cell (SCell), the CORESET #0 may not be configured for the terminal.

A search space may be a set of candidate resource regions through which PDCCHs can be transmitted. The terminal may perform a blind decoding on each of the PDCCH candidates within a predefined search space. The terminal may determine whether a PDCCH is transmitted to itself by performing a cyclic redundancy check (CRC) on a result of the blind decoding. When it is determined that a PDCCH is a PDCCH for the terminal itself, the terminal may receive the PDCCH.

A PDCCH candidate constituting the search space may consist of CCEs selected by a predefined hash function within an occasion of the CORESET or the search space. The search space may be defined and configured for each CCE aggregation level. In this case, a set of search spaces for all CCE aggregation levels may be referred to as a ‘search space set’. In the exemplary embodiments, ‘search space’ may mean ‘search space set’, and ‘search space set’ may mean ‘search space’.

A search space set may be logically associated with one CORESET. One CORESET may be logically associated with one or more search space sets. A common search space set configured through the PBCH may be used to monitor a DCI scheduling a PDSCH for transmission of the SIB1. The ID of the common search space set configured through the PBCH may be set to 0. That is, the common search space set configured through the PBCH may be defined as a type 0 PDCCH common search space set or a search space set #0. The search space set #0 may be logically associated with the CORESET #0.

The search space set may be classified into a common search space set and a terminal-specific (i.e., UE-specific) search space set. A common DCI may be transmitted in the common search space set, and a terminal-specific DCI may be transmitted in the terminal-specific search space set. Considering degree of freedom in scheduling and/or fallback transmission, a terminal-specific DCI may also be transmitted in the common search space set. For example, the common DCI may include resource allocation information of a PDSCH for transmission of system information, paging, power control commands, SFI, preemption indicator, and the like. The terminal-specific DCI may include PDSCH resource allocation information, PUSCH resource allocation information, and the like. A plurality of DCI formats may be defined according to the payload and the size of the DCI, the type of radio network temporary identifier (RNTI), or the like.

In the exemplary embodiments below, the common search space may be referred to as ‘CSS’, and the common search space set may be referred to as ‘CSS set’. Also, in the exemplary embodiments below, the terminal-specific search space may be referred to as ‘USS’, and the terminal-specific search space set may be referred to as ‘USS set’.

In the following exemplary embodiments, ‘signaling’ may mean a combination of one or more among physical (PHY) layer signaling (e.g., DCI), medium access control (MAC) signaling (e.g., MAC control element (CE)), and RRC signaling (e.g., master information block (MIB), system information block (SIB), cell-specific RRC signaling, terminal-specific RRC signaling, etc.). In addition, signaling (or configuration) may mean both of signaling (or configuration) by an explicit scheme and signaling (or configuration) by an implicit scheme. In the following exemplary embodiments, ‘signal’ may be used to mean ‘physical layer signal’ and ‘physical layer channel’. For example, a downlink signal may include a downlink physical layer signal (e.g., DM-RS, CSI-RS, phase tracking (PT)-RS, SS/PBCH block, etc.) and a downlink physical layer channel (e.g., PDCCH, PDSCH).

Exemplary embodiments of the present disclosure may be applied to various communication scenarios using unlicensed bands. For example, with assistance of a primary cell in a licensed band, a cell in unlicensed bands may be configured as a secondary cell, and a carrier in the secondary cell may be aggregated with another carrier. Alternatively, a cell in the unlicensed cell (e.g., secondary cell) and a cell in the licensed band (e.g., primary cell) may support dual connectivity operations. Accordingly, the transmission capacity can be increased. Alternatively, a cell in unlicensed bands may independently perform functions of a primary cell. Alternatively, a downlink carrier of the licensed band may be combined with an uplink carrier of unlicensed bands, and the combined carriers may perform functions as one cell. On the other hand, an uplink carrier of the licensed band may be combined with a downlink carrier of unlicensed bands, and the combined carriers may perform functions as one cell. In addition, exemplary embodiments of the present disclosure may be applied to other communication system (e.g., communication systems supporting licensed bands) as well as communication systems supporting unlicensed bands.

In the communications in unlicensed bands, a contention-based channel access scheme may be used to satisfy spectrum regulation conditions and coexist with existing communication nodes (e.g., Wi-Fi stations). For example, a communication node desiring to access a channel in unlicensed bands may identify a channel occupancy state by performing a clear channel assessment (CCA) operation. A transmitting node (e.g., communication node performing a transmitting operation) may determine whether a channel is in a busy or idle state based on a predefined (or preconfigured) CCA threshold. When the state of the channel is the idle state, the transmitting node may transmit a signal and/or a channel in the corresponding channel. The above-described operation may be referred to as ‘listen before talk (LBT) operation’.

The LBT operation may be classified into four categories according to whether the LBT operation is performed and how it is applied. The first category (e.g., LBT category 1) may be a scheme in which the transmitting node does not perform the LBT operation. That is, when the first category is used, the transmitting node may transmit a signal and/or a channel without performing the channel sensing operation (e.g., CCA operation). The second category (e.g., LBT category 2) may be a scheme in which the transmitting node performs the LBT operation without a random back-off operation. The LBT category 2 may be referred to as ‘one-shot LBT operation’. The third category (e.g., LBT category 3) may be a scheme in which the transmitting node performs the LBT operation based on a random backoff value (e.g., random backoff counter) according to a contention window (CW) of a fixed size. The fourth category (e.g., LBT category 4) may be a scheme in which the transmitting node performs the LBT operation based on a random backoff value according to a contention window of a variable size. In the third and the fourth category, the contention window may be extended based on the random backoff value, during which the channel sensing operation (e.g., CCA operation) is performed. The transmitting node may perform an initial channel sensing operation. The transmitting node may perform the contention window extension if the initial channel sensing operation is failed.

Meanwhile, the LBT operation may be performed in unit of a specific frequency bundle. The frequency bundle may be referred to as a ‘channel’, subband', subband', or ‘resource block (RB) set’. In embodiments, a LBT subband or a subband may mean a RB set. The LBT operation may include the above-described CCA operation. Alternatively, the LBT operation may include ‘the CCA operation+transmission operation of the signal and/or the channel according to the CCA operation’. The bandwidth of the LBT subband and the channel may vary depending on spectrum regulation, frequency bands, communication systems, operators, manufacturers, etc. For example, the bandwidth of the channel may be 20 MHz in the 5 GHz frequency band. The communication node may perform sensing and data transmission operations in unit of 20 MHz or in unit of a frequency bundle corresponding to 20 MHz.

The LBT subband may be a set of consecutive RBs. The size of the LBT subband may correspond to the bandwidth of the channel (e.g., 20 MHz). The base station may configure the LBT subband to the terminal. The configuration information of the LBT subband may include information of the set of RBs constituting the LBT subband (e.g., start RB index and end RB index, start RB index and the number of RBs). One carrier and/or one bandwidth part may include at least one LBT subband. When the carrier consists of a plurality of LBT subbands, configuration information of each LBT subband may be signaled to the terminal.

When the carrier and/or bandwidth part consists of a plurality of LBT subbands, a guard band may be inserted between adjacent LBT subbands. The guard band may be arranged within the carrier. For distinguishing the guard band outside the carrier, the guard band arranged in the carrier may be referred to as ‘intra-carrier guard band’, ‘intra-cell guard band’, or the like. For convenience in embodiments, the above-described guard band may be referred to as a ‘guard band’. The guard band may be a set of consecutive RBs. The RB constituting the guard band may be referred to as a guard RB. When the number of LBT subband(s) constituting the carrier is L, (L-1) guard bands may be arranged on the carrier. L may be a natural number. The size of some guard band(s) may be zero.

The base station may inform the terminal of the information of the frequency range of each LBT subband constituting the carrier (e.g., start CRB index and end CRB index, start CRB index and the number of CRBs (or the number of RBs)) and/or the number of LBT subbands through the signaling procedure (e.g., RRC signaling procedure). Alternatively, the base station may inform the terminal of the information of the frequency range of each guard band constituting the carrier (e.g., start CRB index and end CRB index, start CRB index and the number of CRBs (or the number of RBs)) and/or the number of guard bands through the signaling procedure (e.g., RRC signaling procedure). The LBT subband and the guard band configured for the carrier may be identically applied to the bandwidth part belonging to the corresponding carrier. That is, the terminal may regard the PRB(s) corresponding to the CRB(s) constituting each LBT subband and each guard band in a bandwidth part as the LBT subband and the guard band for the corresponding bandwidth part. The entire frequency range of a LBT subband may be included in the bandwidth part. Alternatively, the entire frequency range of a LBT subband may not be included in the bandwidth part. That is, a LBT subband may not be partially included in the bandwidth part.

The union of RBs constituting the LBT subband(s) and guard band(s) may be identical with the set of RBs constituting the carrier (or bandwidth part). That is, each RB constituting the carrier (or bandwidth part) may belong to at least one LBT subband or one guard band. At the same time or separately, the RB sets constituting each LBT subband and each guard band may be disjoint sets. That is, each RB constituting the carrier (or bandwidth part) may belong to only one LBT subband or only one guard band. In this case, the terminal may identify the frequency range of the LBT subband(s) based on the configuration information of the guard band received from the base station. For example, the start RB of the first subband may be the start RB of the carrier, and the end RB of the first subband may be the RB immediately before the start RB of the first guard band. For another example, the start RB of the last subband may be the RB immediately after the last RB of the last guard band, and the end RB of the last subband may be the end RB of the carrier.

The guard band may be independently configured for each of the downlink and the uplink. Therefore, the LBT subband may also be independently configured for each of the downlink and the uplink. The frequency range of the guard band (e.g., start CRB index and end CRB index, start CRB index and the number of CRBs (or the number of RBs)) may be predefined in the technical specification. When the information of the frequency range of the guard band is not received from the base station, the terminal may determine the frequency range of the LBT subband(s) and the guard band(s) based on the frequency range of the guard band defined in the technical specification.

The communication node (e.g., base station, terminal) may perform the LBT operation and occupy the LBT subband(s) in which the CCA operation is succeeded. That is, the communication node may initiate the COT in the LBT subband(s) in which the CCA operation is succeeded. The communication node may transmit a signal during the COT period in the occupied LBT subband(s). The base station may indicate to the terminal information of available LBT subband(s) and/or unavailable LBT subband(s). The above-described information may be transmitted to the terminal together with the configuration information of the COT. Alternatively, the above-described information may be included in the configuration information of the COT, and the configuration information of the COT may be transmitted to the terminal. The base station may determine that one or more of the LBT subbands occupied by the base station is the available LBT subband(s). The communication node may not transmit the signal in the guard band. Alternatively, the communication node may transmit the signal in the guard band. For example, when transmission is performed on two LBT subbands adjacent to the guard band, transmission may be performed in the guard band at least at the same time.

In the communications in unlicensed bands, the transmitting node may occupy the channel for some time when the LBT operation is successful. In this case, a channel occupancy time or a channel occupancy interval may be referred to as ‘channel occupancy time (COT)’ or ‘channel occupancy (CO)’. That is, the COT or CO may mean a time period during which a channel is occupied by the communication node (e.g., base station or terminal). The expression that the transmitting node succeeds in the LBT operation may mean that the transmitting node acquires a COT. The transmitting node may transmit a signal and/or a channel using a part or all of the COT initiated by the transmitting node. In addition, the COT initiated by the transmitting node may be shared with a receiving node (e.g., communication node performing a receiving operation). Here, the LBT operation may be performed to identify an occupancy state of the channel, a use state, or an access state. The LBT operation may mean a channel sensing operation, an operation for identifying the occupancy state, an operation for identifying the channel state, or an operation for identifying the access state.

Within the COT shared between the transmitting node and the receiving node, the receiving node may perform a transmitting operation as well as the receiving operation. Therefore, the transmitting node may perform a receiving operation as well as the transmitting operation within the shared COT. In the exemplary embodiments, the ‘transmitting node’ may refer to a node that starting or initiating a COT (e.g., initiating node), and the ‘receiving node’ may refer to a node that transmits and receives a signal within the corresponding COT without starting or initiating the corresponding COT.

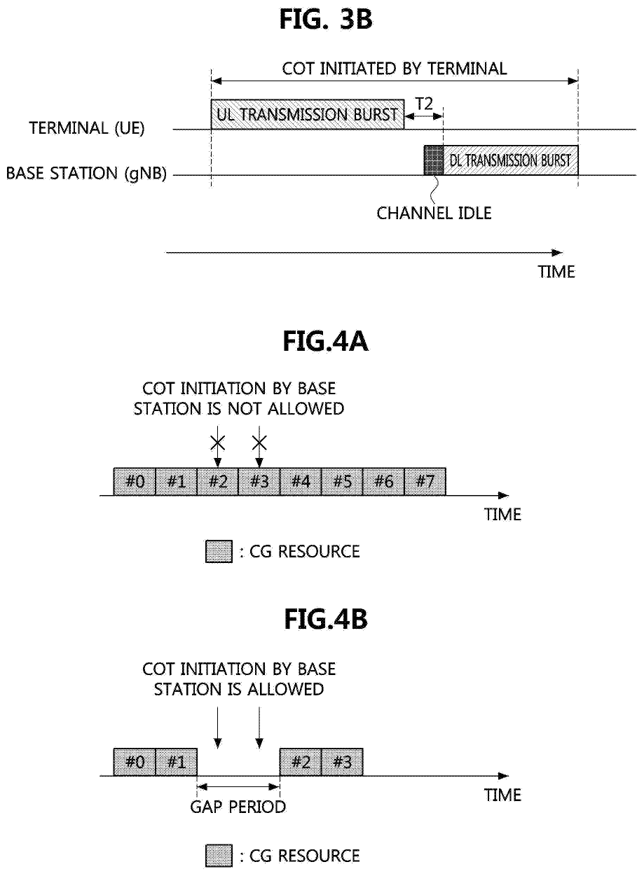

FIG. 3A is a conceptual diagram illustrating a first exemplary embodiment of a method for communications within a COT.

Referring to FIG. 3A, a base station (e.g., gNB) may acquire a COT by performing a CCA operation. The base station may transmit a downlink transmission burst at the beginning part of the COT. The downlink transmission burst may be a set of consecutive downlink signals and/or channels in the time domain. An uplink transmission burst may be a set of consecutive uplink signals and/or channels in the time domain. The expression that the signals and/or channels constituting the downlink transmission burst and the uplink transmission burst are consecutive in the time domain may mean that a gap between transmissions of the signals and/or channels is less than or equal to a reference value. For example, the reference value may be 0. Alternatively, the reference value may be a value greater than 0 (e.g., 16 μs). The COT initiated by the base station may be shared with a terminal. The terminal may transmit an uplink transmission burst within the shared COT.

In this case, the terminal may perform an LBT operation for transmission of the uplink transmission burst. For example, the terminal may perform a CCA operation after the transmission of the downlink transmission burst is completed. When it is determined that a channel state is idle as a result of the CCA operation, the terminal may transmit the uplink transmission burst. Alternatively, the terminal may transmit the uplink transmission burst without performing a CCA operation. For example, when a time interval (e.g., T1) between the downlink transmission burst and the uplink transmission burst is equal to or less than a preconfigured value (e.g., 16 μs), the terminal may transmit the uplink transmission burst without performing a CCA operation. T1 may be a time interval between an ending time point of the downlink transmission burst and a starting time point of the uplink transmission burst.

FIG. 3B is a conceptual diagram illustrating a second exemplary embodiment of a method for communications within a COT.

Referring to FIG. 3B, the terminal may acquire a COT by performing a CCA operation. The terminal may transmit an uplink transmission burst at the beginning part of the COT. The COT initiated by the terminal may be shared with the base station. The base station may transmit a downlink transmission burst within the shared COT. In this case, the base station may perform an LBT operation for transmission of the downlink transmission burst. For example, the base station may perform the CCA operation after the transmission of the uplink transmission burst is completed. When it is determined that a channel state is idle as a result of the CCA operation, the base station may transmit the downlink transmission burst. Alternatively, the base station may transmit the uplink transmission burst without performing a CCA operation. For example, when a time interval (e.g., T2) between the uplink transmission burst and the downlink transmission burst is equal to or less than a preconfigured value (e.g., 16 μs), the base station may transmit the downlink transmission burst without performing a CCA operation. T2 may be a time interval between an ending time point of the uplink transmission burst and a starting time point of the downlink transmission burst.

The maximum occupancy time (or maximum signal-transmittable time) of the channel according to the CCA operation may be defined as a maximum COT (MCOT). In exemplary embodiments, the MCOT of the channel according to the CCA operation performed by the base station may be referred to as ‘downlink MCOT’, and the MCOT of the channel according to the CCA operation performed by the terminal may be referred to as ‘uplink MCOT’. Therefore, the COT initiated by the base station may not exceed the downlink MCOT, and the COT initiated by the terminal may not exceed the uplink MCOT. The downlink MCOT may be predefined in the technical specification depending on a spectrum regulation, a channel access priority class, and the like. The uplink MCOT may be predefined in the technical specification depending on a spectrum regulation, a channel access priority class, and the like. Alternatively, the base station may inform the terminal of the uplink MCOT.

A transmitting node (or a receiving node) may inform the receiving node (or the transmitting node) of information about the COT (e.g., configuration information of the COT) obtained by itself using the signaling procedure (e.g., DCI signaling, uplink control information (UCI) signaling, RRC signaling, etc.). The configuration information of the COT may include a start point of the COT, an end point of the COT, a duration of the COT (e.g., a length of the COT), and so on. The configuration information of the COT that the transmitting node (or the receiving node) informs the receiving node (or the transmitting node) may be different from the information about the COT actually obtained by the transmitting node. The configuration information of the COT may be dynamically or semi-statically indicated. Alternatively, the configuration information of the COT may be predefined and shared among nodes in advance.

For example, the base station may inform the terminal of the configuration information of the COT initiated by itself. In this case, the specific operation of the terminal may depend on the configuration information of the COT obtained from the base station. For example, the PDCCH monitoring operation within the COT configured by the base station may be different from the PDCCH monitoring operation outside the COT configured by the base station. Specifically, outside the COT, the terminal may perform a blind decoding operation for DM-RS of PDCCH candidate(s), and may not perform a blind decoding operation for data of PDCCH candidate(s). In addition, the terminal may perform a PDCCH monitoring operation for a relatively large number of PDCCH candidates in some sections in the COT (e.g., the first slot of a downlink transmission burst). The terminal may perform a PDCCH monitoring operation for a relatively few number of PDCCH candidates in some other sections in the COT (e.g., remaining slot(s) except for the first slot of the downlink transmission burst). Therefore, the terminal may reduce power consumption according to the PDCCH monitoring operation by obtaining the configuration information of the COT from the base station.

The terminal may inform the base station of the configuration information of the COT initiated by itself. In this case, the specific operation of the base station may depend on the configuration information of the COT received from the terminal. For example, the transmission operation of the base station in the COT shared between the base station and the terminal may be determined based on the configuration information of the shared COT.

Meanwhile, a communication node (e.g., the base station, the terminal) performing the LBT operation in unlicensed bands may be classified into a load-based equipment (LBE) and a frame-based equipment (FBE). In addition, the LBT operation scheme may include a LBE operation scheme and a FBE operation scheme. When the LBE operation scheme is used, the communication node may attempt to occupy the channel by performing an additional CCA operation after the CCA operation fails. For example, the LBE may perform the LBT operation based on the random backoff value according to the contention window. The LBT operation scheme according to the third and fourth categories may be included in the LBE operation scheme. ‘CCA operation fails’ may mean ‘the channel is not occupied by the CCA operation’.

When the FBE operation scheme is used, the communication node may perform the CCA operation at the start time or immediately before the start time per a fixed frame or a fixed frame period (FFP). When the CCA operation fails, the communication node may not re-perform the CCA operation until the execution time (e.g., start time or immediately before start time) of the CCA operation in a next fixed frame or a next FFP. On the other hand, when the CCA operation succeeds at the start time or immediately before the start time of any FFP, the FBE may continuously perform transmission and reception during the FFP. The FFP may consist of a COT (or MCOT) and an idle period. The idle period may be 5% of the total length of the COT or the FFP.

For example, when the FFP is 10 ms, the COT (or MCOT) and the idle period constituting the FFP may be 9.5 ms and 0.5 ms, respectively. The idle period may be placed just before the COT. The communication node may perform the LBT operation in the idle period and occupy the channel for the maximum COT (or MCOT) when the channel is determined to be idle as a result of performing the LBT operation. The LBT operation performed by the FBE in the idle period or a gap period (e.g., gap period in COT) may be the LBT operation according to the second category. Alternatively, the LBT operation performed by the FBE in the idle period or the gap period (e.g., gap period in COT) may be different from the LBT operation according to the first to fourth categories. For example, the FBE may perform an energy detection operation for a slot duration with at least T μs length in the idle period or the gap period. The FBE may determine the channel state based on a comparison between a result of performing the energy detection operation and a threshold value for the energy detection. T may be predefined in the technical specification. For example, T may be 9. The above-described LBT operation may be referred to as ‘LBT operation according to category 2-1’. The FBE operation scheme may be used in an environment in which other communication systems do not coexist is ensured in terms of the spectrum regulation. For example, the FBE operation scheme in the NR or LTE system may be used in an environment in which a WiFi system and a device do not coexist.

In the FBE operation scheme, COT may be initiated by the base station. When the LBT operation is successful in the idle period, the base station may transmit a downlink transmission burst to the terminal from the start time of the COT. The COT initiated by the base station may be shared with the terminal. In this case, the terminal may transmit an uplink transmission burst to the base station in the shared COT. In addition, in the FBE operation scheme, the COT may be initiated by the terminal. When the LBT operation is successful in the idle period, the terminal may transmit an uplink transmission burst to the base station from the start time of the COT. The COT initiated by the terminal may be shared with the base station. In this case, the base station may transmit a downlink transmission burst to the terminal in the shared COT.

The base station may transmit configuration information for the LBT operation to the terminal. The configuration information for the LBT operation may be transmitted through higher layer signaling (e.g., RRC signaling, SIB, SIB1). The configuration information for the LBT operation may include information indicating the LBT operation scheme (e.g., LBE operation scheme or FBE operation scheme) performed in the terminal. The terminal may receive the configuration information for the LBT operation from the base station. When the FBE operation scheme is used, the configuration information for the LBT operation may further include information about the FFP (e.g., FFP or length of FFP). The terminal may determine a location of each FFP, a location of the COT constituting each FFP, and/or a location of the idle period constituting each FFP in the time domain based on the configuration information of the LBT operation (e.g., information about the FFP) and predefined rules. The FFP performed (or initiated) by the base station may be distinguished from the FFP performed (or initiated) by the terminal. The terminal may receive information about the FFP performed by the base station from the base station. At the same time or separately, the terminal may receive information about the FFP performed by the terminal from the base station.

The following embodiments may be applied to both the LBE operation scheme and the FBE operation scheme. In the following embodiments, the COT may mean the COT based on the LBE operation. Also, in the following embodiments, the COT may mean the COT based on the FBE operation.

The following embodiments may be applied for the COT initiated by the base station as well as the COT initiated by the terminal.

Meanwhile, an uplink data channel (e.g., PUSCH) may be scheduled by a dynamic grant (DG) or a configured grant (CG). For example, the DG may be a DCI including scheduling information, and the base station may transmit the DG (e.g., DCI) to the terminal through a downlink control channel (e.g., PDCCH). In addition, the CG may include information for semi-static configuration, semi-persistent configuration, and/or dynamic reconfiguration of scheduling information, and the base station may transmit the CG to the terminal through higher layer signaling (e.g., RRC signaling) and/or physical layer dynamic signaling. In the following exemplary embodiments, a channel (e.g., PDCCH, PDSCH, PUCCH, PUSCH, etc.) may refer to ‘signal including data and/or control information’ or ‘radio resource used for transmitting and receiving the signal’.

The terminal may receive configuration information of a resource region (hereinafter, referred to as a ‘CG resource’) in which a PUSCH scheduled by the CG can be transmitted from the base station. When uplink traffic (e.g., uplink-shared channel (UL-SCH)) is generated, the terminal may transmit a PUSCH (e.g., data, control information) in the CG resource without transmission of a separate scheduling request (SR) and reception of a DG according to the SR.

In unlicensed bands, the terminal may start or initiate a COT by transmitting a PUSCH according to a CG. In the exemplary embodiment shown in FIG. 3B, the uplink transmission burst of the terminal may be initiated in the PUSCH according to the CG. That is, the beginning part of the uplink transmission burst of the terminal (e.g., symbols from the first symbol to the X-th symbol (i.e., X symbols) or slots from the first slot to the Y-th slot (i.e., Y slots)) may be occupied by the PUSCH according to the CG. In this case, the terminal may perform a random backoff-based LBT operation (e.g., LBT category 3 or LBT category 4) for channel access. The PUSCH may be transmitted in the CG resource. A plurality of CG resources configured by the base station to the terminal may be continuous or discontinuous in a specific time period.

FIG. 4A is a conceptual diagram illustrating a first exemplary embodiment of a method of configuring CG resources, and FIG. 4B is a conceptual diagram illustrating a second exemplary embodiment of a method of configuring CG resources.

Referring to FIG. 4A, the base station may transmit to the terminal configuration information of eight CG resources (e.g., CG resources #0 to #7) continuous within a time period. That is, the eight CG resources may be contiguous in the time domain. The terminal may receive the configuration information of the CG resources from the base station, and may determine that the eight consecutive CG resources are configured within the time period. The terminal may acquire a COT by performing an LBT operation. In this case, the terminal may transmit a PUSCH continuously in up to the eight CG resources. Here, ‘the CG resources are continuous in the time domain’ may mean ‘the gap between the CG resources is less than a reference value’. For example, the reference value may be 0. For another example, the reference value may be a value greater than 0 (e.g., 16 μs).

Meanwhile, the terminal may not perform a signal reception operation according to semi-static configuration in symbols in which the CG resource(s) are configured. For example, the base station may not configure the terminal to perform both a semi-static transmission operation and a semi-static reception operation on the same symbol (e.g., a symbol is set as a flexible symbol by semi-static slot format configuration). That is, the terminal may not expect that the base station configures the above-described operation. Therefore, when a symbol is configured as the CG resource, the terminal may not perform the reception operation (e.g., reception operation of PDCCH, PDSCH by downlink SPS, SS/PBCH block, CSI-RS, positioning reference signal (PRS), etc.) on the symbol. In this case, it may be difficult for the base station to perform a COT acquisition operation and a downlink signal transmission operation for the terminal before termination of the time period (e.g., the time period in which the eight CG resources are configured). In the exemplary embodiment shown in FIG. 4A, it may be difficult for the base station to start or initiate a COT for the terminal within a period corresponding to the CG resource #2 or #3. The base station may have to wait until a downlink period after the end of the time period to which the eight consecutive CG resources belong in order to transmit a downlink signal to the terminal. Therefore, the downlink transmission may be delayed.

Referring to FIG. 4B, the base station may transmit to the terminal configuration information of four CG resources (e.g., CG resources #0, #1, #2, and #3) discontinuous within a time period. That is, the four CG resources may be discontinuous in the time domain. A gap period may exist between the CG resource #1 and the CG resource #2. The terminal may receive the configuration information of the CG resources from the base station, and may determine that four discontinuous CG resources are configured within the time period. In this case, even when the terminal succeeds in an LBT operation, it may be difficult for the terminal to continuously transmit a plurality of PUSCHs in the CG resources. The above-described configuration (e.g., operation scheme) may be helpful in view of the COT initiation of the base station.

For example, in the exemplary embodiment shown in FIG. 4B, when the LBT operation is successful in the gap period between the CG resource #1 and the CG resource #2, the base station may transmit a downlink transmission burst. The transmission of the downlink transmission burst may start in the gap period. A transmission delay of the downlink transmission burst in the exemplary embodiment shown in FIG. 4B may be shorter than the transmission delay of the downlink transmission burst in the exemplary embodiment shown in FIG. 4A. That is, a performance gain of the downlink communication in the exemplary embodiment shown in FIG. 4B may be higher than a performance gain of the downlink communication in the exemplary embodiment shown in FIG. 4A. When the CG resources are configured discontinuously in the time domain, this may help to provide a balance between downlink and uplink channel accesses.

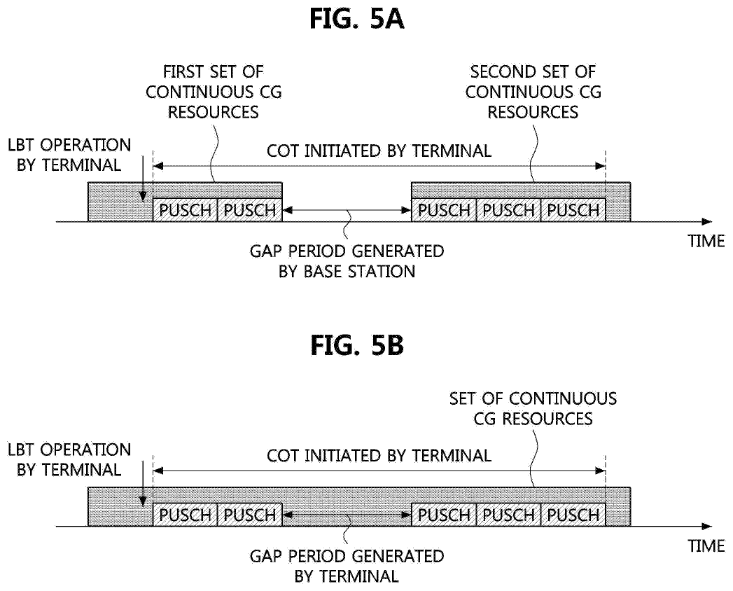

FIG. 5A is a conceptual diagram illustrating a first exemplary embodiment of a discontinuous PUSCH transmission method within one COT, and FIG. 5B is a conceptual diagram illustrating a second exemplary embodiment of a discontinuous PUSCH transmission method within one COT.

Referring to FIG. 5A, a terminal having successfully performed an LBT operation may start a COT by transmitting a PUSCH in a CG resource. In this case, CG resources configured in the terminal may be discontinuous in time within the COT initiated by the terminal. That is, a gap period may exist between a first set of continuous CG resources and a second set of continuous CG resources. The terminal may transmit the PUSCH(s) in the first set of continuous CG resources, may not transmit the PUSCH in the gap period, and may transmit the PUSCH(s) in the second set of continuous CG resources. That is, the terminal may transmit a plurality of PUSCH discontinuously within one COT. The plurality of PUSCHs may be discontinuous in the time domain.

Referring to FIG. 5B, a terminal having successfully performed an LBT operation may start a COT by transmitting a PUSCH in a CG resource. In this case, CG resources configured in the terminal may be continuous in time within the COT initiated by the terminal. The terminal may transmit the PUSCH discontinuously in one set of continuous CG resources within the COT. In this case, the resource(s) in which the PUSCH is transmitted and/or the resource(s) in which the PUSCH is not transmitted may be determined by the terminal.

In the following exemplary embodiments, a method for a terminal to discontinuously transmit an uplink signal (e.g., PUSCH) within a COT and a method for supporting discontinuous transmission of an uplink signal will be described. The COT may be a COT initiated by the terminal or a COT initiated by the base station. The following exemplary embodiments may be applied to the COT initiated by the base station as well as the COT initiated by the terminal. When the terminal performs a discontinuous uplink transmission operation within one COT, a first set of continuous uplink signals (e.g., the first set) may be referred to as ‘first uplink transmission burst’, and a second set of continuous uplink signals (e.g., the second set) may be referred to as ‘second uplink transmission burst’. In the time domain, the second uplink transmission burst may be located after the first uplink transmission burst. In the exemplary embodiments shown in FIGS. 5A and 5B, the first uplink transmission burst may include two PUSCHs, and the second uplink transmission burst may include three PUSCHs.

Meanwhile, according to the spectrum regulation of unlicensed bands, transmission idle time may not be allowed between the first uplink transmission burst and the second uplink transmission burst. In order to solve this problem, when a COT initiated by a transmitting node (e.g., terminal) is shared with a receiving node (e.g., base station), the receiving node may transmit a downlink signal in a gap period. For this operation, the terminal may transmit to the base station information indicating whether the COT initiated by the terminal itself is shared with the base station through signaling. For example, the information indicating whether the COT initiated by the terminal is shared with the base station may be included in uplink control information (UCI), and the UCI may be transmitted from the terminal to the base station. The terminal may map the UCI to a partial region or the entire region of the CG resource(s), and may transmit the UCI to the base station along with a PUSCH according to the CG. Alternatively, the terminal may transmit the above-described UCI to the base station as part of the PUSCH by the CG. That is, the UCI may be piggybacked on the PUSCH.

In addition, the terminal may inform the base station of a period (or a duration) (hereinafter, referred to as ‘downlink period’) in which the base station can transmit a downlink signal within the COT initiated by the terminal. Configuration information of the downlink period may be included in UCI, the UCI may be transmitted from the terminal to the base station. In addition, the UCI including the configuration information of the downlink period may be piggybacked on a PUSCH. The configuration information of the downlink period may include at least one of information indicating whether the COT initiated by the terminal is shared with the base station, a starting time point of the downlink period, an ending time point of the downlink period, and a duration of the downlink period. The base station may receive the configuration information of the downlink period from the terminal, and may determine whether the COT initiated by the terminal is shared with the base station based on the configuration information of the downlink period. The downlink period within the COT initiated by the terminal may be configured in units of symbols or slots. That is, the downlink period may include X symbol(s) and/or Y slot(s).

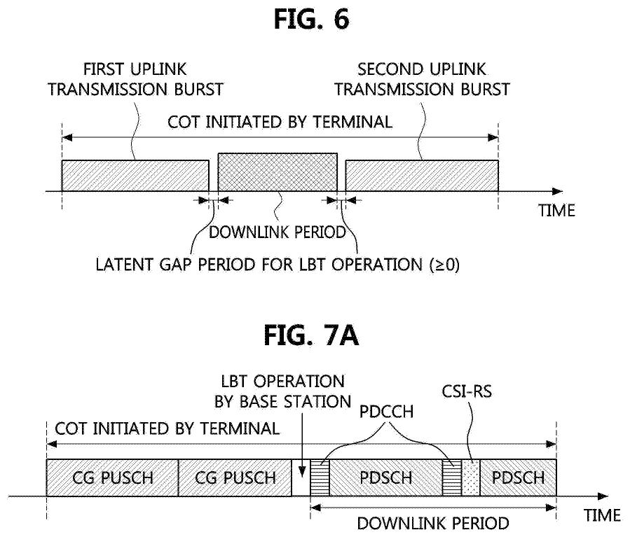

FIG. 6 is a conceptual diagram illustrating a first exemplary embodiment of a method for configuring a downlink period within a COT initiated by a terminal.

Referring to FIG. 6, the terminal may discontinuously transmit the first uplink transmission burst and the second uplink transmission burst within the COT initiated by the terminal itself. That is, in the time domain, the first uplink transmission burst may be discontinuous with the second uplink transmission burst. The terminal may configure a partial region or the entire region of the gap period between the first uplink transmission burst and the second uplink transmission burst as the downlink period, and transmit configuration information of the downlink period to the base station. The downlink period may be used for downlink transmission. In this case, a gap period (e.g., latent gap period) for an LBT operation may exist between the first uplink transmission burst and the downlink period, and a gap period (e.g., potential gap period) for an LBT operation may exist between the downlink period and the second uplink transmission burst.

In order to ensure continuous signal transmission in the entire time period (e.g., time period except the period(s) for the LBT operation(s) within the COT) within the COT initiated by the terminal, it may have to be guaranteed that the base station transmits downlink signals in the entire downlink period configured by the terminal. This operation may be implemented by the following exemplary embodiments.

[Method for Downlink Communications Within a COT]

In a first method, the position of the time resource in which the downlink period may be arranged may be limited. This method may be referred to as ‘Method 100’. In a first exemplary embodiment of Method 100, the base station may transmit configuration information of a time resource region and/or a frequency resource region to the terminal, and the time and/or frequency position of the downlink period may be limited within the resource region configured by the base station. The time resource region (hereinafter, referred to as ‘downlink resource pool’) in which the downlink period may be arranged may be explicitly configured. In this case, the downlink resource pool may consist of a set of symbol(s) and/or a set of slot(s). The downlink resource pool may appear periodically and repeatedly, and the location of the downlink resource pool in a period may be configured for the terminal. In addition, the period of the downlink resource pool may be predefined. Alternatively, the base station may configure the period of the downlink resource pool for the terminal. The downlink resource pool may include symbol(s) for a specific use. The symbol(s) for the specific use may be a symbol(s) in which a CORESET, PDCCH monitoring occasions or search space sets associated with the CORESET, channel state information-reference signal (CSI-RS) resources, positioning reference signal (PRS) resources, a window for receiving and measuring a discovery reference signal (DRS), and/or downlink semi-persistent scheduling (SPS) resources are(is) configured. The base station may inform the terminal of information on symbol(s) for the specific use included in the downlink resource pool.

The DRS may mean a set of signals and channels for initial access, cell search, cell selection, radio resource management (RRM), and/or RRM reporting of the terminal. The DRS may basically include a synchronization signal/physical broadcast channel (SS/PBCH) block. In addition, the DRS may further include a CORESET (or PDCCH search space associated with the CORESET), a PDSCH, and/or a CSI-RS in addition to the SS/PBCH block. For example, the DRS may include a CORESET #0 and a PDCCH search space set #0 associated with the CORESET #0. A DCI (e.g., DCI scheduling a PDSCH including a system information block 1 (SIB1)) may be transmitted through a PDCCH candidate in a resource of the PDCCH search space set #0 associated with the CORESET #0. A window related to DRS reception and measurement may be an SS/PBCH block measurement timing configuration (SMTC), a radio link monitoring (RLM) measurement window, and/or an RRM measurement window.

When the specific symbol(s) (e.g., the specific symbol(s) belonging to the time resource region configured by the base station) are included in the downlink period, the terminal may expect the base station to transmit a downlink signal in the specific symbol(s). For example, when the symbol(s) in which the CORESET or the PDCCH monitoring occasions are configured are included in the downlink period, the terminal may expect to receive at least one PDCCH successfully in the corresponding symbol(s). Alternatively, when the symbol(s) in which the window for DRS reception and measurement is configured are included in the downlink period, the terminal may expect to receive a downlink signal and a channel including the DRS in the corresponding symbol(s). Alternatively, when the symbol(s) in which the SPS resources are configured are included in the downlink period, the terminal may expect to receive a PDSCH in the corresponding symbol(s). In addition, a PDSCH may be transmitted in the above-described symbol(s). The PDSCH may be a PDSCH scheduled by a dynamic grant. For example, the base station may transmit the PDSCH along with other signals and channels (e.g., PDCCH, CSI-RS, DRS, SPS PDSCH, etc.) in the above-described symbol(s) based on a frequency division multiplexing (FDM) scheme.

In a second method, the symbol(s) constituting the downlink period may be predefined. Alternatively, the symbol(s) constituting the downlink period may be used for a preconfigured use. The base station may configure the preconfigured use to the terminal. The use of symbol(s) constituting the downlink period may be one or more. This method may be referred to as ‘Method 110’. For example, the terminal may assume that the PDCCH monitoring occasions are allocated in some or all of the symbol(s) included in the downlink period, and may perform a PDCCH monitoring operation on the symbol(s) in which the PDCCH monitoring occasions are allocated. The base station may preconfigure a CORESET and/or a search space set for the PDCCH monitoring occasions in the terminal. For example, the CORESET may be allocated in each symbol or some symbols of the downlink period, and a duration of the corresponding CORESET may pre-defined in advance. Alternatively, the base station may configure the duration of the corresponding CORESET to the terminal. For example, the duration of the corresponding CORESET may be one symbol. In addition, the above-described configuration information of the CORESET and/or search space set for the PDCCH monitoring occasion allocated in the downlink period (e.g., configuration information of CORESET and/or search space set defined in technical specification) may be signaled to the terminal. According to the above-described method, the position of the PDCCH monitoring occasion may be determined by the terminal. That is, the terminal may determine the position of the symbol(s) in which PDCCHs are monitored by informing the base station of the position of the downlink period within the COT initiated by the terminal itself.

In a third method, the base station may compulsorily transmit a downlink signal in the symbol(s) constituting the downlink period. In this case, a type of the downlink signal, a downlink time resource, a downlink frequency resource, and/or a downlink transmission scheme may be determined by the base station (in the manner of implementation). The type of the downlink signal may be limited to a part of physical layer signals and channels. The operation of the base station within the downlink period may be explicitly defined in the technical specification. Alternatively, the base station may inform the terminal of at least one of the operations of the base station in the downlink period. For example, the base station may inform the terminal of the physical layer signal(s) and channel(s) that the terminal may expect to receive in the downlink period through signaling. This method may be referred to as ‘Method 120’.

Meanwhile, when there is no downlink signal and/or data to be transmitted by the base station or when the size of the downlink signal and/or data to be transmitted by the base station is small, the terminal may share a COT initiated by the terminal with the base station. In addition, the terminal may configure a downlink period within the COT, and may transmit configuration information of the downlink period to the base station. This operation may not be desirable in terms of downlink transmission. However, this operation may be helpful for discontinuous uplink transmission. In order to ensure continuous signal transmission in the downlink period, the base station may transmit a dummy signal in the downlink period. The period in which the base station can transmit the dummy signal may be limited. For example, the base station may transmit the dummy signal in the downlink period within the COT initiated by the terminal. The dummy signal may be a signal arbitrarily generated and transmitted by the base station. The dummy signal may be a signal defined in the technical specification. When the dummy signal is defined in the technical specification, a downlink signal and a channel used for a specific purpose may be used as the dummy signal. For example, the PDCCH, PDSCH, DM-RS, CSI-RS, TRS, PRS, SS/PBCH block (or at least some signals and/or channels of SS/PBCH block), etc. may be used as the dummy signal. When the dummy signal is defined in the technical specification, the terminal may perform operations for receiving the dummy signal (e.g., blind decoding operation, reception processing operation according to a result of the blind decoding operation, measurement operation of RRM/RLM/CSI, etc.). Alternatively, the terminal only assumes that the dummy signal is transmitted, and may not perform the reception operation or measurement operation of the dummy signal.

Alternatively, the terminal may share the COT with the base station only when there is a downlink signal and/or data to be transmitted by the base station. For this operation, the base station may transmit downlink buffer status information (i.e., buffer status report (B SR)) to the terminal. The downlink buffer status information may include information about the amount of traffic stored in a downlink buffer of the base station. The downlink buffer status information may be defined in a form similar to uplink buffer status information that the terminal reports to the base station. In addition, for the purpose of informing the terminal of the presence of downlink traffic or for the purpose of sharing the COT initiated by the terminal, the base station may inform the terminal of a logical channel identifier (LCID), a logical channel group (LCG), and the like for downlink traffic transmission. For example, the LCID and the LCG may be transmitted to the terminal through MAC signaling (e.g., MAC CE).

The above-described methods may be combined with each other, and the combined methods may be used. For example, Method 120 may be combined with Method 100 and/or Method 110, and the combined methods may be used. For example, when the resource arrangement condition of Method 100 is satisfied, Method 120 may be used. Method 100 may be combined with Method 110, and ‘Method 100+Method 110’ may be used.

The above-described methods may be used when specific conditions are satisfied. For example, the above-described methods may be used when uplink transmission is performed after the downlink period within the COT initiated by the terminal or when uplink transmission is expected to be performed after the downlink period within the COT initiated by the terminal. That is, the above-described methods may be used when the downlink period is located in the middle of the COT initiated by the terminal or when the downlink period does not include ending symbol(s) of the COT initiated by the terminal. The terminal may transmit to the base station information indicating whether uplink transmission is performed. The size of the information indicating whether uplink transmission is performed may be 1 bit. Whether to perform uplink transmission may be determined according to whether the above-described signaling is performed. The information indicating whether uplink transmission is performed may be included in UCI, and the UCI may be piggybacked on a PUSCH. The terminal may transmit to the base station the information indicating whether uplink transmission is performed, information indicating whether the COT initiated by the terminal is shared with the base station, and the configuration information (e.g., position information) of the downlink period within the COT initiated by the terminal.

A plurality of downlink periods may be configured within the COT initiated by the terminal. The terminal may transmit configuration information of the plurality of downlink periods to the base station. In this case, the above-described methods may be applied to each of the downlink periods. For example, Method 100 to Method 120 may be applied to each of the downlink periods. The terminal may signal configuration information (e.g., position information) of each downlink period to the base station. Alternatively, the terminal may signal information indicating whether uplink transmission is performed after each downlink period to the base station.

Alternatively, when a plurality of downlink periods are configured and indicated within the COT initiated by the terminal, the above-described methods may be applied to specific downlink period(s). For example, the terminal may signal information indicating whether uplink transmission is performed after the last downlink period to the base station. Whether uplink transmission is performed after the remaining downlink period(s) except the last downlink period among the plurality of downlink periods may be determined according to whether another downlink period exists after the corresponding downlink period.

For example, the COT initiated by the terminal may be shared with the base station, and the terminal may transmit configuration information (e.g., position information) of each of two downlink periods within the COT to the base station. In this case, the base station may expect to receive an uplink transmission burst after the first downlink period because there is the second downlink period within the COT. Information indicating whether uplink transmission is performed after the second downlink period within the COT may be transmitted from the terminal to the base station.

[Method for Intercepting a COT]

The COT initiated by the terminal may be shared with the base station, and the base station may transmit a downlink signal (e.g., PDCCH, PDSCH, CSI-RS, DRS, etc.) in a downlink period within the corresponding COT. The downlink signal may be limited to a downlink signal for the terminal that started (or initiated) the COT shared with the base station. Alternatively, the downlink signal may be a downlink signal for another terminal other than the terminal that initiated the COT. Alternatively, the downlink signal may include a downlink signal for another terminal as well as the downlink signal for the terminal that initiated the COT. For example, ‘when the downlink signal is a signal including control information’ or ‘when the downlink signal is a broadcast signal (e.g., PDSCH including system information and/or PDCCH corresponding to the PDSCH, a group common PDCCH, etc.)’, the downlink signal may be transmitted to other terminals as well as the terminal initiating the COT.

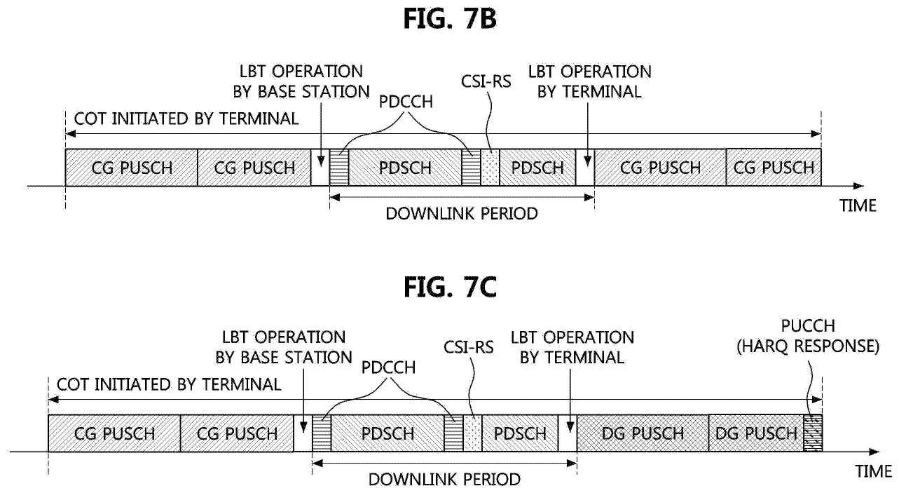

FIG. 7A is a conceptual diagram illustrating a first exemplary embodiment of a method of transmitting a downlink signal within a COT initiated by a terminal, FIG. 7B is a conceptual diagram illustrating a second exemplary embodiment of a method of transmitting a downlink signal within a COT initiated by a terminal, and FIG. 7C is a conceptual diagram illustrating a third exemplary embodiment of a method of transmitting a downlink signal within a COT initiated by a terminal.

Referring to FIGS. 7A to 7C, a configured grant (CG) PUSCH may be a PUSCH scheduled by a CG and a dynamic grant (DG) PUSCH may be a PUSCH scheduled by a DG. In the exemplary embodiment shown in FIG. 7A, the COT initiated by the terminal may be shared with the base station, and the base station may transmit a downlink signal (e.g., PDCCH, PDSCH, CSI-RS, etc.) in a downlink period within the COT. The downlink signal transmitted in the downlink period within the COT may be a downlink signal for the terminal that initiated the COT and/or another terminal.

In addition, the terminal may transmit an uplink transmission burst to the base station after the downlink period within the COT. In this case, the uplink transmission burst may include a CG PUSCH (e.g., PUSCH scheduled by a CG). Alternatively, the uplink transmission burst may include another uplink signal (e.g., PUSCH scheduled by a DG) in addition to the PUSCH by the CG.

In the exemplary embodiments shown in FIGS. 7B and 7C, the terminal may transmit a first uplink transmission burst within the COT, the base station may transmit a downlink transmission burst in the downlink period after the first uplink transmission burst, and the terminal may transmit a second uplink transmission burst after the downlink transmission burst. In the exemplary embodiment shown in FIG. 7B, the second uplink transmission burst may include a CG PUSCH (e.g., PUSCH scheduled by a CG). When the period in which the second uplink transmission burst is to be transmitted is configured as a CG resource, the terminal may continuously transmit a PUSCH(s) scheduled by one or more CGs. In this case, the terminal (e.g., terminal initiating COT) may not expect to receive an uplink grant scheduling a PUSCH in the previous downlink period within the COT initiated by the terminal.

In the exemplary embodiment shown in FIG. 7C, the second uplink transmission burst may include a PUSCH and/or another uplink signal scheduled by a CG. For example, the terminal may transmit a PUSCH scheduled by a DG or a PUSCH by dynamic scheduling in the second uplink transmission burst. Here, the terminal may be a terminal initiating the COT. The terminal may receive the dynamic grant (e.g., uplink DCI) in the previous downlink period within the COT initiated by the terminal. The base station may configure or indicate information of the LBT operation (e.g., LBT type or category, LBT gap, or time gap with the previous transmission, etc.) performed for the transmission of the PUSCH (or transmission of the second uplink transmission burst) to the terminal. The terminal may obtain information of the LBT operation performed for the transmission of the PUSCH (or transmission of the second uplink transmission burst) from the base station. The information of the LBT operation may be included in the dynamic grant (e.g., uplink DCI) scheduling the PUSCH, and the dynamic grant including the information of the LBT operation may be transmitted to the terminal. The LBT type or category may include at least one of first, second, third, and fourth category LBTs. In addition, the base station may configure or indicate information of a channel access priority class (CAPC) for the PUSCH to the terminal. The terminal may obtain the information of the CAPC for the PUSCH from the base station. The information of the CAPC may be included in the dynamic grant (e.g., uplink DCI) scheduling the PUSCH, and the dynamic grant including the information of the CAPC may be transmitted to the terminal. The range of the CAPC may be determined by the CAPC used by the terminal to perform the LBT operation for initiating the COT. For example, the CAPC may not have a higher priority than the CAPC used by the terminal to perform the LBT operation for initiating the COT. When the LBT operation is performed according to the CAPC, the terminal may determine a size of the contention window for the random backoff. The contention window may be referred to as a collision window. Alternatively, the range of the CAPC may be determined irrespective of the CAPC used by the terminal to perform the LBT operation for initiating the COT.

In addition, the terminal may transmit a PUCCH in the second uplink transmission burst. The PUCCH may include an HARQ response (e.g., HARQ acknowledgement (HARQ-ACK)) for a PDSCH. Here, the PDSCH may be a PDSCH received in the (previous) downlink period(s) within the COT (e.g., the same COT) initiated by the terminal. Alternatively, the PDSCH may be a PDSCH received before the COT initiated by the terminal. The PDSCH may be the PDSCH by the dynamic grant. Alternatively, the PDSCH may be the PDSCH by the downlink SPS. The PUCCH may include a CSI report, a beam measurement report, and/or a scheduling request. Each of the CSI report and the beam measurement report may include aperiodic measurement information for a CSI-RS and/or a DRS received in the (previous) downlink period(s) within the COT (e.g., the same COT) initiated by the terminal. The PUCCH transmission may be triggered by the dynamic grant (e.g., downlink DCI, uplink DCI, group common DCI).

When the base station obtains uplink buffer status information from the terminal, the exemplary embodiment shown in FIG. 7C may be more effective than the exemplary embodiment shown in FIG. 7B. When the base station knows the buffer status of the terminal, DG-based PUSCH transmission by scheduling of the base station may be more efficient than CG-based PUSCH transmission. For this operation, the terminal may transmit a PUSCH (e.g., CG PUSCH) including the buffer status information within the COT initiated by the terminal itself. The PUSCH including the buffer status information may be transmitted in the first uplink transmission burst. In addition, the buffer status information may be included in one or more PUSCHs in the first uplink transmission burst. The one or more PUSCHs including the buffer status information may be PUSCHs (e.g., K PUSCHs) from the first PUSCH to the K-th PUSCH in the first uplink transmission burst. K may be 1.

In the exemplary embodiment shown in FIG. 7C, when the second uplink transmission burst period includes a CG resource, the terminal may transmit a CG PUSCH as well as another uplink signal in the uplink transmission burst period (e.g., CG resource in the uplink transmission burst period). For example, the terminal may transmit a PUSCH (e.g., DG-based PUSCH), a PUCCH, an SRS, a PRACH, or the like using the CG resource within the COT. In this case, the priority of another uplink signal may be regarded as higher than the priority of the CG PUSCH. For example, the priority of the uplink transmission by the dynamic grant (e.g., SRS, PUCCH, PUSCH by the dynamic grant) may be higher than the priority of the PUSCH by the CG. A transmission operation of the uplink signal (e.g., uplink signal having the priority higher than that of the CG PUSCH) may be performed by indication or configuration of the base station. The base station may transmit to the terminal ‘information indicating the above-described transmission operation of the uplink signal’ and ‘configuration information of the above-described transmission operation of the uplink signal’ in the downlink period within the same COT (e.g., COT initiated by the terminal). When the COT initiated by the terminal is shared with the base station, the base station may transmit control information to the terminal in the downlink period within the same COT (e.g., COT initiated by the terminal), so that the base station can use some or all of the remaining period (e.g., period not configured as the downlink period or the uplink period) of the COT as intended by the base station. That is, when the COT initiated by the terminal is shared with the base station, the base station may intercept the corresponding COT, and may use some or all of the remaining period of the corresponding COT together with the COT initiated by the base station.

In the embodiment shown in FIG. 7c, the base station may not receive ‘information indicating the end time of the COT initiated by the terminal’ or ‘information indicating whether the time period that the base station schedules the uplink transmission belongs to the COT initiated by the terminal’ from the terminal. In this case, the base station may schedule the uplink transmission regardless of whether the time period during that the base station schedules the uplink transmission belongs to the COT initiated by the terminal. Alternatively, the base station may obtain ‘information indicating the end time of the COT initiated by the terminal’ or ‘information indicating whether the time period that the base station schedules the uplink transmission belongs to the COT initiated by the terminal’ from the terminal. The information may be included in the UCI, and the UCI may be transmitted to the base station with the PUSCH or without the PUSCH. In this case, the base station may schedule the uplink transmission based on whether the time period that the base station schedules the uplink transmission belongs to the COT initiated by the terminal. For example, the above-described method of determining the transmission priority, the LBT operation, the CAPC, etc. may be applied only when the time period that the base station schedules the uplink transmission belongs to the COT initiated by the terminal.

The base station may selectively perform the exemplary embodiment shown in FIG. 7B and the exemplary embodiment shown in FIG. 7C. When the COT initiated by the terminal is shared with the base station, the base station may configure or instruct the terminal a behavior of uplink signal transmission in an uplink period after the downlink period by transmitting a control message to the terminal in the downlink period within the corresponding COT. The terminal may transmit an uplink signal according to the instruction or configuration of the base station. In this case, the terminal may not transmit a PUSCH by a CG in the uplink period. Alternatively, the terminal may transmit a PUSCH by a CG in a period in the uplink period, for which transmission of an uplink signal is not instructed or configured.

Alternatively, the base station may signal to the terminal information indicating whether a CG PUSCH can be transmitted in the uplink period (e.g., the uplink period within the COT initiated by the terminal). Alternatively, the base station may signal to the terminal information indicating to release a CG resource configured in the terminal in the uplink period (e.g., the uplink period within the COT initiated by the terminal). Alternatively, when the COT initiated by the terminal is shared with the base station, the base station may signal to the terminal information indicating whether the corresponding COT is intercepted. The terminal may determine whether a CG PUSCH can be transmitted in the uplink period through one or more of the above-described signaling schemes, and may perform an uplink operation according to the determination result.

The above-described exemplary embodiments may be generalized to a case where a plurality of downlink periods exist within the COT initiated by the terminal. In this case, an uplink transmission burst (or uplink period) may exist after each downlink period. Whether an uplink transmission burst exists after the last downlink period may be determined according to the arrangement of the downlink period(s) configured by the terminal. In this case, the signaling method and the transmission method of the control message (e.g., control information) of the base station, which are applied to the above-described exemplary embodiments, may be applied to each downlink period or an arbitrary downlink period within the COT. In addition, the uplink transmission method of the terminal applied to the above-described exemplary embodiments may be applied to uplink transmission burst(s) or uplink period(s) after the first downlink period within the COT.

[Early Termination of a COT]

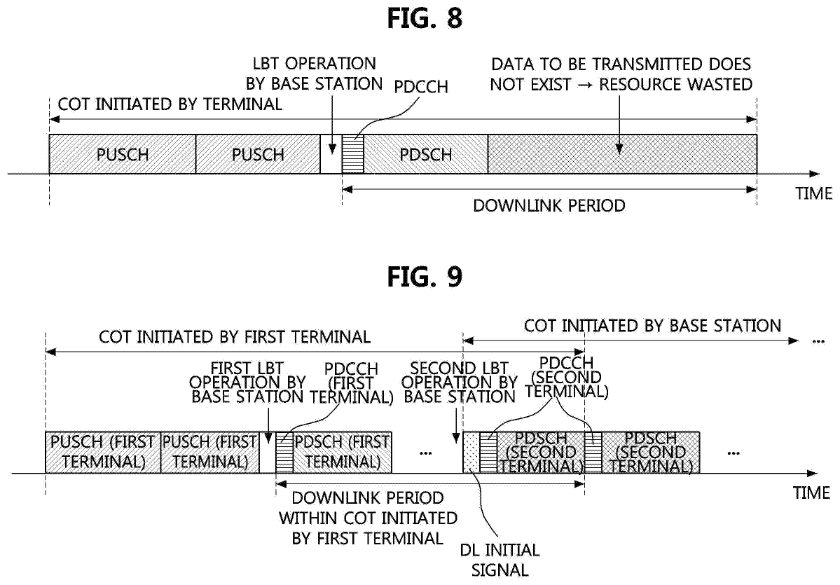

FIG. 8 is a conceptual diagram illustrating a fourth exemplary embodiment of a method for transmitting a downlink signal within a COT initiated by a terminal.

Referring to FIG. 8, the terminal may configure a predetermined time period within the COT initiated by the terminal as a downlink period, and transmit information (e.g., configuration information) indicating the downlink period to the base station. When there is no downlink signal and data to be transmitted to the terminal that initiated the COT or when a size of a downlink signal and data to be transmitted to the terminal that initiated the COT is small, a part of the downlink period may be unnecessary for downlink transmission for the terminal that initiated the COT. In this case, it may be assumed that the base station can transmit at least some downlink signals (e.g., PDSCH including UE-specific data or unicast information and/or PDCCH corresponding to the PDSCH) only to the terminal that initiated the COT in the downlink period. According to the above assumption, even when a downlink signal and data to be transmitted to a terminal other than the terminal that initiated the COT exist at the base station, the base station may not use a part of the downlink period for the downlink transmission. Therefore, an unused period may occur within the downlink period, and resource utilization may decrease.

As a method for solving the above problem, when the COT initiated by the terminal is shared with the base station, the base station may early terminate the corresponding COT. Specifically, the base station may perform an LBT operation in the downlink period within the COT shared with the terminal, and may transmit a downlink transmission burst by accessing the channel when the LBT operation is successful. This operation may be referred to as ‘Method 200’. The LBT operation performed in Method 200 may be a separate LBT operation different from the LBT operation performed by the base station immediately before or at the beginning part of the downlink period to obtain the downlink period.

The channel access operation (e.g., LBT operation) performed in Method 200 may be a random backoff-based LBT operation (e.g., LBT category 3 or LBT category 4). When a downlink transmission burst to be transmitted through the LBT operation includes short control signaling (e.g., DRS), the LBT operation may be an LBT operation (e.g., LBT category 2) without random backoff. The channel access operation (e.g., LBT operation) performed in the method 200 may not be distinguished from the channel access operation performed in a period outside the COT initiated by the terminal. Further, the downlink transmission burst in Method 200 may be distinguished from the downlink transmission burst transmitted according to the LBT operation performed immediately before or at the beginning part of the downlink period (e.g., the downlink transmission burst belonging to the COT initiated by the terminal).

Method 200 may be used when there is no uplink transmission burst or uplink period after the downlink period. Alternatively, Method 200 may be used when the downlink period is allocated at the ending part of the COT. The terminal may signal to the base station information indicating whether an uplink transmission burst is present after the downlink period and/or information indicating whether the downlink period is allocated at the ending part of the COT. The base station may receive from the terminal the information indicating whether an uplink transmission burst is present and/or the information indicating whether the downlink period is allocated at the ending part of the COT.

FIG. 9 is a conceptual diagram illustrating a first exemplary embodiment of a method for early terminating a COT initiated by a terminal.

Referring to FIG. 9, a first terminal may acquire a COT by succeeding in an LBT operation, and may transmit a PUSCH (e.g., CG PUSCH) within the COT. In addition, the first terminal may share the COT initiated by itself with the base station, and may transmit configuration information (e.g., indication information) of a downlink period within the corresponding COT to the base station. The base station may identify the downlink period within the COT based on the configuration information received from the terminal. The base station may perform a first LBT operation immediately before or at the beginning part of the downlink period, and may transmit a PDCCH and a PDSCH for the first terminal and/or other terminals at the beginning part of the downlink period when the first LBT operation is successful. In addition, when there is no downlink signal and data to be transmitted to the first terminal, the base station may perform Method 200. For example, the base station may terminate the COT shared with the terminal during the downlink period.

Specifically, the base station may perform a second LBT operation in the downlink period. When the second LBT operation is successful, the base station may transmit a new downlink transmission burst before the end of the downlink period. The new downlink transmission burst may include a signal (e.g., PDCCH, PDSCH, CSI-RS, etc.) for a terminal (i.e., second terminal) other than the first terminal. For example, PDSCH and/or PDCCH for other terminal (i.e., second terminal) not the first terminal included in the new downlink transmission burst may be the PDSCH including the UE-specific data or the unicast information and/or the PDCCH corresponding to the PDSCH, respectively. Alternatively, the new downlink transmission burst may include a signal (e.g., DRS) for a terminal group. A downlink (DL) initial signal may be allocated at the beginning part of the new downlink transmission burst. The terminal may identify the new downlink transmission burst by successfully detecting the downlink initial signal, and may perform a transmission operation in the COT initiated by the base station and a reception operation (e.g., PDCCH monitoring operation) for the new downlink transmission burst. In particular, when the downlink initial signal is successfully detected, the first terminal may determine that the base station has early terminated the COT initiated by the first terminal.

Various downlink signals and channels may be used as the downlink initial signal. For example, a DM-RS for demodulating a PDCCH (hereinafter, referred to as ‘PDCCH DM-RS’) may be used as the downlink initial signal. Alternatively, a wideband DM-RS of a CORESET may be used as the downlink initial signal. In this case, the wideband DM-RS may not be used for demodulation of a PDCCH. Alternatively, a DM-RS for demodulation of a group common PDCCH (hereinafter, referred to as ‘group common PDCCH DM-RS’) may be used as the downlink initial signal. Alternatively, a group common PDCCH DM-RS and control information included in a group common PDCCH may be used as the downlink initial signal. Alternatively, a wideband DM-RS for demodulation of a group common PDCCH (hereinafter, referred to as ‘group common PDCCH wideband DM-RS’) and control information included in a group common PDCCH may be used as the downlink initial signal. In this case, when a group common DCI is successfully received (e.g., when a cyclic redundancy check (CRC) on the group common DCI is successful), the terminal may detect the downlink transmission burst. Alternatively, a CSI-RS may be used as the downlink initial signal.

The group common PDCCH may include a specific DCI format. The control information included in the group common PDCCH may correspond to a payload of a specific DCI format. For example, in the NR communication system, the group common PDCCH may use a DCI format 2_0 or a DCI format modified (or extended) from the DCI format 2_0. The DCI format may include information (e.g., configuration information) of the COT initiated by the base station. The above operations may also be applied when the group common PDCCH is used.

The terminal may identify the new downlink transmission burst by detecting successfully a group common PDCCH (e.g., DCI format 2_0) or control information included in a group common PDCCH (e.g., SFI included in the DCI format 2_0, information on the end time of the COT or the COT duration, information indicating available or unavailable LBT subband(s), information indicating switching the search space set, etc.). The terminal may perform a reception operation for the new downlink transmission burst (e.g., a PDCCH monitoring operation) and a transmission operation within the COT initiated by the base station.

When Method 200 is used, it may be difficult to distinguish the downlink initial signal transmitted in the downlink period within the COT from a general PDCCH and/or PDCCH DM-RS according to the signal and/or channel that the terminal regards as the downlink initial signal. For example, when a PDCCH DM-RS is used as the downlink initial signal, it may be difficult for the first terminal to distinguish between the PDCCH received within the COT initiated by the first terminal and the PDCCH received within the COT newly initiated by the base station. For another example, when the group common PDCCH DM-RS is used as the downlink initial signal, it may be difficult for the first terminal to distinguish between the group common PDCCH DM-RS received within the COT initiated by the first terminal and the PDCCH DM-RS (e.g., the downlink initial signal) received within the COT newly initiated by the base station. In this case, even when the base station initiated transmission of the new downlink transmission burst in the downlink period, the terminal may not recognize that the base station terminated the COT early.

As a method for solving the above-mentioned problem, a group common PDCCH DM-RS, a group common PDCCH wideband DM-RS, control information included in a group common PDCCH, ‘group common PDCCH DM-RS+control information included in a group common PDCCH’, or ‘group common PDCCH wideband DM-RS+control information included in a group common PDCCH’ may be used as the downlink initial signal. When the group common PDCCH DM-RS, the group common PDCCH wideband DM-RS, the control information included in the group common PDCCH, the ‘group common PDCCH DM-RS+control information included in the group common PDCCH’, or the ‘group common PDCCH wideband DM-RS+control information included in the group common PDCCH’ is successfully detected in the downlink period within the COT initiated by the terminal, the terminal may regard the detected signal as the downlink initial signal of the COT newly initiated by the base station.

When the downlink initial signal includes a group common PDCCH DM-RS or a group common PDCCH wideband DM-RS (e.g., when the downlink initial signal does not include control information included in the group common PDCCH), an initialization function or polynomial for generating a sequence of each of the group common PDCCH DM-RS and the group common PDCCH wideband DM-RS may be cell-specific, and the corresponding sequence may be commonly applied to a PDCCH transmitted in a CSS set as well as the group common PDCCH. For example, the sequence may be a function of a physical layer cell ID, a slot index, a symbol index, or the like. The sequence may not be a function of a terminal unique identifier (e.g., C-RNTI). In this case, when a PDCCH DM-RS or a PDCCH wideband DM-RS is successfully detected in a CSS set belonging to the downlink period within the COT initiated by the terminal, the terminal may regard the detected PDCCH DM-RS or PDCCH wideband DM-RS as the downlink initial signal of the COT newly initiated by the base station.

As another method for solving the above-described problem, when a specific signal (e.g., group common PDCCH, DCI format 2_0) or information included in the specific signal (e.g., SFI included in the DCI format 2_0, information on the end time of the COT or the COT duration, information indicating available or unavailable LBT subband(s), information indicating switching the search space set, etc.) is received, the terminal may assume that the specific signal or the transmission of the specific signal belongs to the downlink transmission burst or a new COT initiated by the base station. Accordingly, the terminal may perform the reception operation for the new downlink transmission burst (e.g., PDCCH monitoring operation) and the transmission operation within the COT initiated by the base station.

As another method for solving the above-described problem, the base station may inform the terminal that a new COT has been initiated in a downlink period within the COT shared with the terminal (e.g., the COT initiated by the terminal). The information may be transmitted to the terminal by an explicit method or an implicit method. The information may be included in DCI, and the DCI including the information may be transmitted to the UE through PDCCH (e.g., group common PDCCH, PDCCH including scheduling information of PDSCH/PUSCH).

[Relation Between COT and DRS]

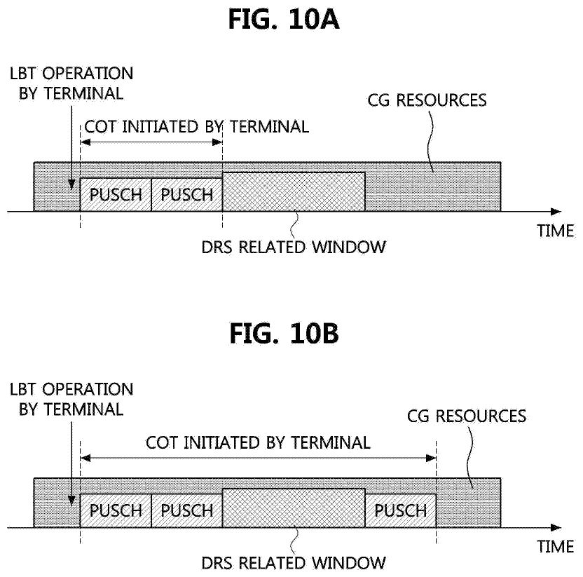

FIG. 10A is a conceptual diagram illustrating a first exemplary embodiment of a channel occupancy method of a terminal considering a DRS related window, and FIG. 10B is a conceptual diagram illustrating a second exemplary embodiment of a channel occupancy method of a terminal considering a DRS related window.

Referring to FIGS. 10A and 10B, CG resources configured in the terminal may overlap a window related to DRS reception and measurement (hereinafter, referred to as ‘DRS related window’). In this case, in the exemplary embodiment shown in FIG. 10A, the DRS related window may not be included in the COT initiated by the terminal. For example, the terminal may release the COT initiated by itself before the start of the DRS related window.

Alternatively, in the exemplary embodiment shown in FIG. 10B, a part of the DRS related window or the entire DRS related window may be included in the COT initiated by the terminal. The terminal may perform a DRS reception and measurement operation in the DRS related window belonging to the COT initiated by the terminal. In addition, when the COT initiated by the terminal is shared with the base station, the base station may transmit a DRS within the corresponding COT. For this operation, the terminal may configure a downlink period within the COT so that the downlink period includes the DRS related window, and transmit configuration information (or indication information) of the downlink period to the base station. In addition, the terminal may transmit an uplink signal after the DRS related window based on the above-described methods.

[PDCCH Monitoring Operation Within COT]

In the downlink period within the COT initiated by the terminal, the base station may transmit a PDCCH and a PDSCH. In this case, in order to support an operation of continuously transmitting a signal in the downlink period, it may be advantageous for the terminal to perform a PDCCH monitoring operation at a short periodicity or a short interval (e.g., interval shorter than one slot, or 10 or less symbols) in the downlink period. On the other hand, in order to support continuous transmission of the base station within the COT initiated by the base station, it may be sufficient for the terminal to perform the PDCCH monitoring operation at a relatively long periodicity or a long interval (e.g., one slot or a plurality of slots). Due to this operation, power consumption of the terminal can be reduced.

The PDCCH monitoring operation within the COT initiated by the terminal may be different from the PDCCH monitoring operation in other period (e.g., outside the COT initiated by the terminal, within the COT initiated by the base station). For this operation, the base station may configure the CORESET and/or search space set for the COT initiated by the terminal independently from the CORESET and/or search space set for other case (e.g., for a general case, for the COT initiated by the base station). The base station may independently configure each of ‘the CORESET and/or search space set for the COT initiated by the terminal’ and ‘the CORESET and/or search space set for other case (e.g., for a general case, for the COT initiated by the base station)’. For example, one or more search space sets associated with a common CORESET for the COT initiated by the terminal may be configured in the terminal, and one or more search space sets associated with a common CORESET for other case (e.g., for a general case, for the COT initiated by the base station) may be configured in the terminal. The one or more search space sets for the COT initiated by the terminal may be configured independently of the one or more search space sets for other case (e.g., for a general case, for the COT initiated by the base station).

When Method 200 is used, the COT initiated by the terminal may be terminated early by the base station. For example, the base station may terminate the COT early in the downlink period within the COT initiated by the terminal. In this case, the terminal may dynamically change the PDCCH monitoring operation in the downlink period within the COT initiated by the terminal. For example, the terminal may perform the PDCCH monitoring operation according to the configuration of the search space set for the COT initiated by the terminal in the corresponding downlink period, and when the COT initiated by the base station is detected in the corresponding downlink period (e.g., when a downlink initial signal is detected), the terminal may perform the PDCCH monitoring operation according to the configuration of the search space set for a relevant case (e.g., for outside the COT initiated by the terminal, for a general case, for the COT initiated by the base station) from a certain time point (e.g., the time point at which the COT initiated by the base station is detected, the time point at which the downlink initial signal is detected).

The above-described PDCCH monitoring operation may be applied only to the terminal initiating the COT. Alternatively, the above-described PDCCH monitoring operation may be applied to a plurality of terminals (e.g., terminal initiating the COT and/or other terminal(s)). Whether or not the above-described PDCCH monitoring operation is applied may be configured in the terminal or in the terminal group.

[COT Multiplexing Method]

When communications in unlicensed bands are performed, a plurality of terminals belonging to one serving cell may simultaneously access the same channel.

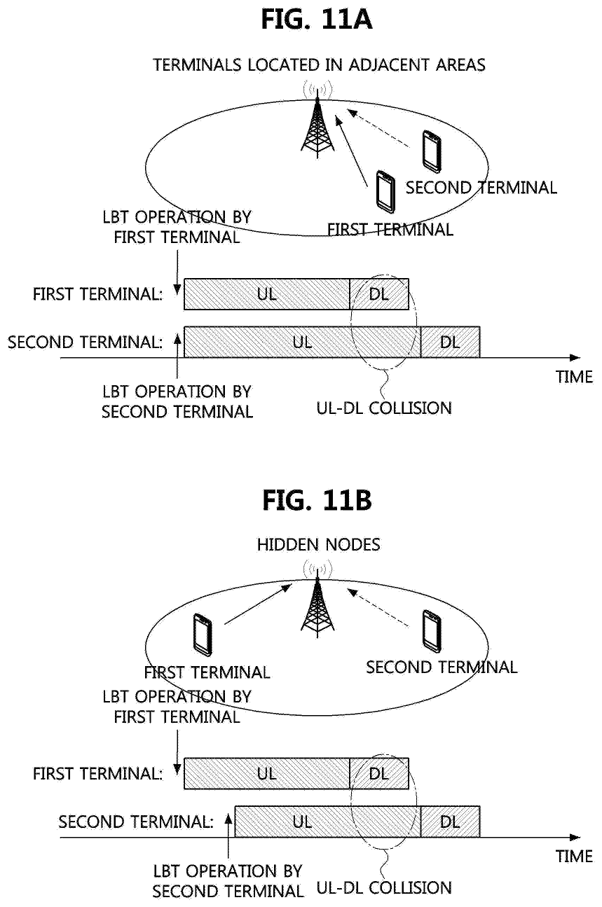

FIG. 11A is a conceptual diagram illustrating a first exemplary embodiment in which a plurality of terminals simultaneously access the same channel, and FIG. 11B is a conceptual diagram illustrating a second exemplary embodiment in which a plurality of terminals simultaneously access the same channel.

Referring to FIG. 11A, a plurality of terminals (e.g., a first terminal and a second terminal) may acquire (or initiate) a respective COT by succeeding in LBT operations at the same time, and transmit uplink transmission bursts at the same time within the respective COT. In this case, an area where the first terminal is located may be geographically close to an area where the second terminal is located. Alternatively, the area where the first terminal is located may be geographically far from the area where the second terminal is located.

Referring to FIG. 11B, a plurality of terminals may acquire (or initiate) a respective COT by succeeding in LBT operations at different time points, and may transmit uplink transmission bursts within the respective COT. In this case, the area where the first terminal is located may be geographically far from the area where the second terminal is located. In terms of the first terminal, the second terminal may be a hidden node, and in terms of the second terminal, the first terminal may be a hidden node.

Even when a plurality of terminals belonging to one serving cell perform uplink transmissions at the same time, there may be no problem in terms of uplink transmission. For example, different frequency resources (e.g., different sets of RBs, different sets of interlace RBs) may be allocated to the plurality of terminals, and the plurality of terminals may transmit uplink signals using the different frequency resources. In this case, even when the plurality of terminals transmit uplink signals at the same time, since the uplink signals are multiplexed in the frequency domain, the base station may normally receive the uplink signals of the plurality of terminals.

When a downlink period is configured within at least one COT among a plurality of COTs initiated by a plurality of terminals, the downlink period within the COT may be an uplink period within the COT initiated by another terminal. That is, an overlap (or collision) may occur between uplink and downlink within the plurality of COTs. For example, in the exemplary embodiments shown in FIGS. 11A and 11B, the downlink period within the COT initiated by the first terminal may collide with the uplink period within the COT initiated by the second terminal. Particularly, when the CCA operation is omitted for transmission in the downlink period (e.g., transmission of the downlink transmission burst) of the COT initiated by the first terminal (e.g., when the first category LBT is performed), transmission collision may actually occur between the downlink period of the COT initiated by the first terminal and the uplink period of the COT initiated by the second terminal.

When the uplink period overlaps with the downlink period within the COTs initiated by different terminals, the base station may selectively perform one operation among an uplink receiving operation and a downlink transmission operation in the overlapping period. The base station may recognize the overlap between the uplink period and the downlink period, and may selectively perform the uplink operation and the downlink operation. On the other hand, it may be difficult for the terminal to know whether the COT initiated by another terminal exists. Therefore, when the uplink period overlaps the downlink period within the plurality of COTs, the base station may perform an uplink reception operation in the overlapping period. Alternatively, the base station may perform a downlink transmission operation in the overlapping period. Alternatively, the base station may compare a transmission priority of the uplink period (e.g., priority of the COT to which the uplink period belongs, transmission priority of signal(s) and/or channel(s) which are transmitted in the uplink period) and a transmission priority of the downlink period (e.g., priority of the COT to which the downlink period belongs, transmission priority of signal(s) and/or channel(s) which are transmitted in the downlink period), the base station may perform an operation corresponding to the period (or COT) having a higher priority. Alternatively, the base station may determine the transmission priority between the uplink period and the downlink period by itself, and perform transmission according to the determined transmission priority. The operation for determining the priority may be performed dynamically. Alternatively, the operation for determining the priority may be semi-static. The above-described information of the transmission priority may be signaled from the base station to the terminal.

Here, the priority of the COT may mean the CAPC used for obtaining the COT, the transmission priority of the signal(s) and/or the channel(s) constituting the COT, and etc. In addition, the transmission priority of the signal (s) and/or channel(s) may mean the transmission priority (e.g., the priority of the logical channel, quality of service (QoS), etc.) identified in the higher layer, the transmission priority identified in the physical layer, and etc. The transmission priority identified in the physical layer may mean a transmission priority given to the physical signal and/or channel, and when transmissions of physical signal(s) and/or channel(s) having different priorities overlap, physical signal(s) and/or channel(s) having high priority may be preferentially transmitted, and transmission of physical signal(s) and/or channel(s) having low priority may be omitted. Alternatively, the physical signal(s) and/or channel(s) having the low priority may be multiplexed to the physical signal(s) and/or channel(s) having the high priority, and the physical signal(s) and/or channel(s) having the low priority may be transmitted with the physical signal(s) and/or channel(s) having the high priority. For example, the transmission priority identified in the physical layer may be configured in two levels (e.g., first priority and second priority). The priority may be transmitted to the terminal by an explicit method or an implicit method through physical layer signaling (e.g., a specific field value of DCI, RNTI by which the CRC of PDCCH is scrambled, search space set, etc.).

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a terminal in a communication system, the operation method comprising:
acquiring a time period for occupying a channel by performing a sensing operation on the channel;
transmitting a first uplink signal to a base station in a first uplink period within the time period;
receiving downlink control information (DCI) from the base station in a downlink period within the time period, the DCI including an uplink grant; and
transmitting a second uplink signal to the base station in a second uplink period indicated by the uplink grant within the time period.

2. The operation method according to claim 1, wherein the second uplink period is located after the downlink period and belongs to the time period.

3. The operation method according to claim 1, wherein information indicating an end time of the time period or information indicating whether the second uplink period belongs to the time period is transmitted from the terminal to the base station.

4. The operation method according to claim 1, wherein the time period initiated by the terminal is shared with the base station, and configuration information of the downlink period is transmitted from the terminal to the base station.

5. The operation method according to claim 1, wherein a transmission resource of the second uplink signal is overlapped with a transmission resource of a physical uplink shared channel (PUSCH) indicated by a configured grant (CG), and the PUSCH indicated by the CG is not transmitted.

6. The operation method according to claim 1, wherein a sensing operation on the channel for transmitting the second uplink signal is performed, and information indicating the sensing operation on the channel for transmitting the second uplink signal is transmitted from the base station to the terminal.

7. The operation method according to claim 1, wherein the second uplink signal includes one or more among a PUSCH, a physical uplink control channel (PUCCH), and a sounding reference signal (SRS), and the PUCCH includes one or more among a hybrid automatic repeat request acknowledgement (HARQ-ACK) for a physical downlink shared channel (PDSCH) received from the base station, channel state information (CSI), measurement information of downlink received signal strength, and a scheduling request.

8. An operation method of a base station in a communication system, the operation method comprising:
receiving a first uplink signal from a terminal in a first uplink period within a time period initiated by the terminal;
transmitting downlink control information (DCI) to the terminal in a downlink period within the time period, the DCI including an uplink grant; and
receiving a second uplink signal from the terminal in a second uplink period indicated by the uplink grant within the time period.

9. The operation method according to claim 8, wherein the second uplink period is located after the downlink period and belongs to the time period.

10. The operation method according to claim 8, wherein information indicating an end time of the time period or information indicating whether the second uplink period belongs to the time period is received from the terminal.

11. The operation method according to claim 8, wherein the time period initiated by the terminal is shared with the base station, and configuration information of the downlink period is received from the terminal.

12. The operation method according to claim 8, wherein a transmission resource of the second uplink signal is overlapped with a transmission resource of a physical uplink shared channel (PUSCH) indicated by a configured grant (CG), and the PUSCH indicated by the CG is not received.

13. The operation method according to claim 8, wherein information indicating whether a third uplink signal according to a CG is transmittable in CG resources indicated by the CG after the downlink period within the time period is transmitted to the terminal in the downlink period.

14. The operation method according to claim 8, wherein the second uplink signal includes one or more among a PUSCH, a physical uplink control channel (PUCCH), and a sounding reference signal (SRS), and the PUCCH includes one or more among a hybrid automatic repeat request acknowledgement (HARQ-ACK) for a physical downlink shared channel (PDSCH) transmitted from the base station, channel state information (CSI), measurement information of downlink received signal strength, and a scheduling request.

15. A terminal in a communication system, the terminal comprising:
a processor; and
a memory storing at least one instruction and electronically communicating with the processor,
wherein when the at least one instruction is executed by the processor, the at least one instruction causes the processor to:
acquire a time period for occupying a channel by performing a sensing operation on the channel;
transmit a first uplink signal to a base station in a first uplink period within the time period;
receive downlink control information (DCI) from the base station in a downlink period within the time period, the DCI including an uplink grant; and
transmit a second uplink signal to the base station in a second uplink period indicated by the uplink grant within the time period.

16. The terminal according to claim 15, wherein the second uplink period is located after the downlink period and belongs to the time period.

17. The terminal according to claim 15, wherein the time period initiated by the terminal is shared with the base station, and configuration information of the downlink period is transmitted from the terminal to the base station.

18. The terminal according to claim 15, wherein a transmission resource of the second uplink signal is overlapped with a transmission resource of a physical uplink shared channel (PUSCH) indicated by a configured grant (CG), and the PUSCH indicated by the CG is not transmitted.

19. The terminal according to claim 18, wherein information indicating that the time period initiated by the terminal is intercepted by the base station is received from the terminal in the downlink period.

20. The terminal according to claim 15, wherein the second uplink signal includes one or more among a PUSCH, a physical uplink control channel (PUCCH), and a sounding reference signal (SRS), and the PUCCH includes one or more among a hybrid automatic repeat request acknowledgement (HARQ-ACK) for a physical downlink shared channel (PDSCH) received from the base station, channel state information (CSI), measurement information of downlink received signal strength, and a scheduling request.
